(19) United States
(12) Patent Application Publication
(10) Pub. No.: US 2024/0096332 A1
(43) Pub. Date: Mar. 21, 2024

(54) AUDIO SIGNAL PROCESSING METHOD, AUDIO SIGNAL PROCESSING APPARATUS, COMPUTER DEVICE AND STORAGE MEDIUM

(71) Applicant: Samsung Electronics Co., Ltd., Suwon-si (KR)

(72) Inventors: Lei YANG, Beijing (CN); Wei LIU, Beijing (CN); Lufen TAN, Beijing (CN)

(21) Appl. No.: 18/524,687

(22) Filed: Nov. 30, 2023

Related U.S. Application Data
(63) Continuation of application No. PCT/IB2023/057440, filed on Jul. 21, 2023.

(30) Foreign Application Priority Data
Jul. 22, 2022 (CN) 202210872180.7
Oct. 24, 2022 (CN) 202211305751.5

(51) Int. Cl. G10L 17/02; G10L 17/04; G10L 17/18; G10L 25/18

(52) U.S. Cl. CPC G10L 17/02; G10L 17/04; G10L 17/18; G10L 25/18

(57) ABSTRACT

An audio signal processing method, an audio signal processing apparatus, a computer device and a storage medium are provided. The audio signal processing method includes acquiring, by using the voice registration module based on a first audio signal, a first hidden state corresponding to a voice registration module is acquired, and, extracting, based on the first hidden state, a target audio signal from a second audio signal.

### CROSS-REFERENCE TO RELATED APPLICATION(S)

This application is a continuation application, claiming priority under § 365(c), of an International application No. PCT/IB2023/057440, filed on Jul. 21, 2023, which is based on and claims the benefit of a Chinese patent application number 202210872180.7, filed on Jul. 22, 2022, in the Chinese Intellectual Property Office, and of a Chinese patent application number 202211305751.5, filed on Oct. 24, 2022, in the Chinese Intellectual Property Office, the disclosure of each of which is incorporated by reference herein in its entirety.

### TECHNICAL FIELD

The disclosure relates to the technical field of artificial intelligence. More particularly, the disclosure relates to an audio signal processing method, an audio signal processing apparatus, a computer device and a storage medium.

### BACKGROUND

The voice extraction technology is a technology to extract the target voice of a specific person from mixed voice signals. The voice extraction technology can be applied in various scenarios such as voice call and online meeting.

In the related art, to improve the quality of the voice extraction of a specific speaker, it is usually necessary to acquire the voice of the specific person in 5 to 10 seconds in advance for registration. However, due to the fact that the specific person's voice required for registration is long, it is not practical to use related technologies to extract voice. Therefore, how to process audio signal to achieve better voice extraction is still a research focus in the art.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an audio signal processing method, an audio signal processing apparatus, a computer device and a storage medium, which can improve the efficiency of audio signal processing and improve the practicability.

Another aspect of the disclosure is to provide an audio signal processing method, including steps of: acquiring, by using a voice registration module based on a first audio signal, a first hidden state corresponding to the voice registration module, and extracting, based on the first hidden state, a target audio signal from a second audio signal.

Another aspect of the disclosure is to provide an audio signal processing method, including steps of: outputting an audio signal to be processed to a user, receiving processing instructions from the user, and extracting, based on the processing instructions, a target audio signal from the audio signal to be processed.

Another aspect of the disclosure is to provide a computer device, including a memory, a processor and computer programs that are stored on the memory, wherein the processor executes the computer programs to implement the steps of the audio signal processing method described above.

Another aspect of the disclosure is to provide a computer-readable storage medium having computer programs stored thereon that, when executed by a processor, implement the steps of the audio signal processing method described above.

Another aspect of the disclosure is to provide a computer program product, including computer programs that, when executed by a processor, implement the steps of the audio signal processing method described above.

Additional aspects will be set forth in part in the description which follows and, in part, will be apparent from the description, or may be learned by practice of the presented embodiments.

In accordance with an aspect of the disclosure, an audio signal processing method is provided. The method includes acquiring, by using the voice registration module based on a first audio signal a first hidden state corresponding to a voice registration module, and extracting a target audio signal from a second audio signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of an implementation environment for implementing an audio signal processing method according to an embodiment of the disclosure;

FIG. 2 is a schematic flowchart of an audio signal processing method according to an embodiment of the disclosure;

FIG. 3 is a schematic structure diagram of an encoder module according to an embodiment of the disclosure;

FIG. 4 is a schematic structure diagram of an encoder module according to an embodiment of the disclosure;

FIG. 5 is a schematic structure diagram of a voice extraction network according to an embodiment of the disclosure;

FIG. 6 is a schematic structure diagram of a voice extraction network according to an embodiment of the disclosure;

FIG. 7 is a schematic diagram of an intra-frame analysis process according to an embodiment of the disclosure;

FIG. 8 is a schematic diagram of an inter-frame analysis process according to an embodiment of the disclosure;

FIG. 9 is a schematic diagram of a core network of a hidden state analysis module according to an embodiment of the disclosure;

FIG. 10 is a schematic structure diagram of a voice registration module according to an embodiment of the disclosure;

FIG. 11A is a timing flowchart of a hidden state analysis module according to an embodiment of the disclosure;

FIG. 11B is a timing flowchart of another hidden state analysis module according to an embodiment of the disclosure;

FIG. 12 is a schematic diagram of a network structure of a voice registration module according to an embodiment of the disclosure;

FIG. 13 is a schematic diagram of hidden state distribution updating according to an embodiment of the disclosure;

FIG. 14 is a schematic structure diagram of a voice extraction module according to an embodiment of the disclosure;

FIG. 15A is a timing flowchart of a voice extraction module according to an embodiment of the disclosure;

FIG. 15B is a timing flowchart of a voice extraction module according to an embodiment of the disclosure;

FIG. 16A is a schematic diagram of a network structure of a voice extraction module according to an embodiment of the disclosure;

FIG. 16B is schematic diagram of a network structure based on a VE-VE network framework according to an embodiment of the disclosure;

FIG. 16C is a schematic diagram of a network structure based on a VE-VE network framework according to an embodiment of the disclosure;

FIG. 16D is a schematic diagram of a corresponding structure of a DPRNN Block of a VE-VE network framework according to an embodiment of the disclosure;

FIG. 17 is a timing flowchart of a voice extraction module according to an embodiment of the disclosure;

FIG. 18 is a schematic structure diagram of a decoding module according to an embodiment of the disclosure;

FIG. 19 is a schematic diagram of a network structure of a decoding module according to an embodiment of the disclosure;

FIG. 20 is a schematic diagram of a network structured applied to other tasks based on a voice extraction network according to an embodiment of the disclosure;

FIG. 21 is a schematic diagram of an interaction scenario of an audio signal processing method according to an embodiment of the disclosure;

FIG. 22 is a schematic diagram of an audio focusing scenario according to an embodiment of the disclosure;

FIG. 23 is a schematic diagram of a scenario of quick switching during audio focusing according to an embodiment of the disclosure;

FIG. 24 is a schematic diagram of a scenario in which target sound is extracted from the video according to an embodiment of the disclosure;

FIG. 25 is a schematic diagram of a scenario in which non-target sound is removed during video recording according to an embodiment of the disclosure;

FIG. 26 is a comparison diagram of the actual measurement results of extracting the voice of a target speaker according to an embodiment of the disclosure;

FIG. 27 is an effect diagram of processing an audio signal by using the method of the application according to an embodiment of the disclosure;

FIG. 28 is a schematic structure diagram of an audio signal processing apparatus according to an embodiment of the disclosure;

FIG. 29 is a schematic structure diagram of an audio signal processing apparatus according to an embodiment of the disclosure; and

FIG. 30 is a schematic structure diagram of a computer device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “comprising” and “including” used in the embodiments of the application mean that corresponding features may be implemented as presented features, information, data, steps and operations, but do not exclude implementations as other features, information, data, steps, operations, etc. as supported in the prior art.

The applicant of the application has studied the technologies in the art and has found that there are the following problems in the related technologies in the art.

1. In the related technologies, the voice extraction technology based on the registration information of the target speaker is to decouple the speech content from the voice signal by using one sentence spoken by the target speaker so as to eliminate the influence from the speech content and obtain a global voice feature vector of the target speaker, and then extract the voice of the target speaker from the mixed audio by using the global voice feature vector. However, since the duration of one complete sentence is long, 5 to 10 seconds of voice is generally used for registration in the related technologies. For example, the global explicit feature vector of the voice of the target speaker in 5 to 10 seconds is extracted for voice registration. Then, the explicit feature vector and the feature vector of the mixed audio are input into a voice extraction network, and the audio of the target speaker in the mixed audio is predicted and extracted by the voice extraction network.

However, since the duration of the voice used for registration is long (at least 5 seconds) in the related technologies, a registration failure is easily caused due to the change of environment (e.g., the generation of environmental noise) during the registration process, so that it is impossible to realize voice extraction. In addition, the registration process can only be completed after the target speaker has spoken for at least 5 seconds, so that it takes a long time for the whole voice extraction process. Therefore, in the related technologies, the efficiency of audio signal processing is low.

The applicant of the application has found through further experiments and research that, if voice extraction is still performed by the above related technologies when the duration of the voice of the target speaker is shortened to 0.5 seconds, the extraction performance will be reduced sharply. The applicant has also conducted a comparative experiment by using the existing voice filter as a standard version and inputting the 5 s registration voice of the speaker and the 0.5 s registration voice of the speaker. The results of the comparative experiment are shown in Table 1 below. When the duration of the input registration voice of the target speaker is decreased from 5 second to 0.5 seconds, the performance index SISDR is decreased by 44.8%, indicating that the performance is reduced sharply. The applicant has found through further research that, in fact, if 0.5 s voice is used for registration by using the related technologies and when the performance index SISDR is 9.1 dB, it is impossible for the existing voice filter to operate normally.

TABLE 1

| Duration of the | | | Performance |
|---|---|---|---|
| registration voice | 5 s | 0.5 s | reduction (%) |
| SISDR(dB) | 16.5 | 9.1 | 44.8 |

The evaluation index SISDR (scale invariant signal-to-distortion ratio) is a common index for evaluating the voice extraction performance, and has a unit of dB. If the value is larger, it indicates that the performance is better.

However, by using the audio signal processing method provided by the application, instant registration can be realized during the registration process of the speaker. The instant registration may also be called ultra-short-time registration, where only 0.5 s voice of the target speaker is needed to obtain the features of the target speaker so as to complete registration and realize voice extraction. The 0.5 s voice contains 2 to 4 words. This is the shortest time for human beings to identify other persons by sound. In the audio signal processing method provided by the application, specifically, a first hidden state corresponding a voice registration module is acquired by using the voice registration based on a first audio signal; and, a target audio signal is extracted from a second audio signal based on the first hidden state, so that the voice extraction can be realized without extracting explicit features from a long piece of audio. Particularly during the registration process of the target speaker, instant registration (ultra-short-time registration) is realized, and the user is allowed to complete registration for an ultra-short time. Accordingly, the user's experience can be improved, the registration process can be seamlessly combined with the voice extraction operation, the voice extraction can be completed quickly and efficiently, and the efficiency and practicability of audio signal processing can be improved. Moreover, the quick and efficient realization of audio signal extraction can make the audio signal processing method of the application applicable to more scenarios, so that the application aspects of the audio signal processing method are expanded. For example, it is applicable to voice extraction, and also applicable to voice enhancement, voice separation, etc.

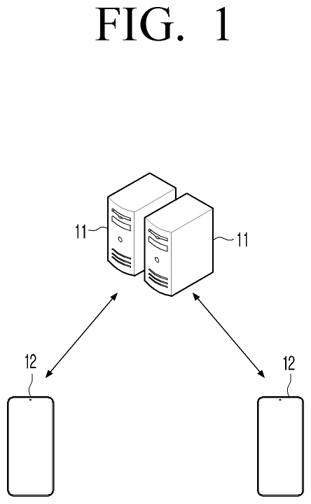

FIG. 1 is a schematic diagram of an implementation environment of an audio signal processing method according to the disclosure.

Referring to FIG. 1, the implementation environment includes a computer device. The computer device may execute the audio signal processing method provided by the application to extract a target audio signal from the mixed audio.

In one possible implementation environment, the computer device may be a terminal, such as a mobile phone, a headphone, a vehicle-mounted terminal or other terminal devices having an audio signal processing function. The terminal may acquire a first audio signal and a second audio signal, and executes the audio signal processing method of the application based on the first audio signal and the second audio signal to extract a target audio signal from the second audio signal. For example, during a voice call, a smart headphone outputs the audio to be processed to a user, and the user can trigger the smart headphone to turn on a voice extraction function when the user hears the voice of the concerned speaker, so that upon receiving an audio signal subsequently, the smart headphone extracts, from the audio signal, the voice of the speaker concerned by the user and then plays the voice.

In another possible implementation environment, the computer device may also be a server 11, and the implementation environment may also include a terminal 12. In one example, the server 11 may execute the audio processing method of the application based on a first audio signal and a second audio signal to extract a target audio signal from the second audio signal, and then return the target audio signal to the terminal 12. For example, in an audio/video playback scenario, the server 11 may only extract the audio of the singer concerned by the user and send it to the terminal 12 of the user. In another example, the implementation environment may also include a terminal 13, and audio signals are transmitted between the terminal 12 and the terminal 13 through the server 11. In the application, the terminal 12 may provide a first audio signal and a second audio signal to the server 11. The server 11 may execute the audio processing method of the application based on the first audio signal and the second audio signal to extract a target audio signal from the second audio signal, and then transmit the target audio signal to the terminal 13. For example, during a voice call, the terminal 12 of the user A transmits the voice of the user A to the server 11, and the server 11 may filter out the noise in the surrounding environment from the voice of the user A, and the server 11 provides, to the terminal 13 of the user B, the voice of the user A after filtering out the noise. It is to be noted that, FIG. 1 is only illustrated by taking the implementation environment including a server 11 and a terminal 12 as an example, but it is not limited in other implementation environments to which the application is applied.

The application is applicable to various scenarios. In one possible scenario example, in a voice call scenario, for example, the audio signal processing method of the application may be used to extract the voice of the target speaker so as to filter out the noise in the surrounding environment. For another example, if it is necessary to quickly switch from one speaker A to another speaker B, the audio signal processing method of the application may be used to extract the voice of the speaker B, thereby quickly switching the target speaker from A to B. In another possible scenario example, such as an audio/video playback scenario, the audio signal processing method of the application may be used to extract the sound of singing of the concerted singer in the audio/video. In another possible scenario example, in an audio/video recording scenario, the audio signal processing method of the application may be used to remove the non-concerned sound in the recorded audio/video, for example, shielding the noise in the environment and other persons' voice, so that only the voice of the concerned person is reserved.

The first audio signal may be an audio signal with a small duration. For example, the first audio signal may be an audio signal with a duration of 0.5 s. The duration of the second audio signal will not be limited in the application. For example, the duration of the second audio signal may be 10 s, 1 min, 5 min, etc. The first audio signal and the second audio signal involved in the application may be audio signals of any format and any type. The format and type of the first audio signal and the second audio signal is not be limited in the application. For example, the type may include, but not limited to: voice, the sound of singing, musical instruments' sound, background music, noise, sound events (e.g., the sound of closing the door, doorbell sound, etc.), etc.; and, the format may include, but not limited to: moving picture experts group (MPEG) audio layer 3 (MP3), advanced audio coding (AAC), WAV, windows media audio (WMA), compact disc (CD) audio (CDA), musical instrument digital interface (MIDI), etc.

The server 11 may be an independent physical server, or a server cluster or distributed system composed of a plurality of physical servers, or a cloud server or server cluster that provides basic cloud computing services such as cloud services, cloud databases, cloud computing, cloud functions, cloud storages, network services, cloud communications and big data and artificial intelligence platforms. The terminal 12 or the terminal 13 may be a smart headphone, a true wireless stereo (TWS), a smart phone, a tablet computer, a notebook computer, an audio/video data acquisition device (e.g., a video recorder, a sound acquisition device, a directional pickup, a smart camera, etc.), a digital broadcast receiver, a desktop computer, a vehicle-mounted terminal (e.g., a vehicle-mounted navigation terminal, a vehicle-mounted computer, etc.), a smart speaker, a smart watch, etc. The terminal and the server may be directly or indirectly connected in a wired or wireless communication manner, or the connection manner may be determined based on the requirements of actual application scenarios. It will not be limited here.

To make the purposes, technical solutions and advantages of the application clearer, the implementations of the application will be further described below in detail with reference to the accompanying drawings.

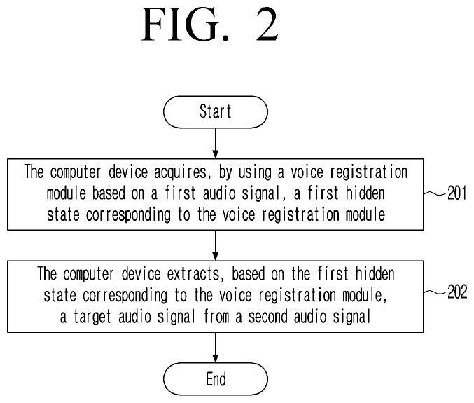

FIG. 2 is a schematic flowchart of an audio signal processing method according to an embodiment of the disclosure. The execution subject of the method may be a computer device.

Referring to FIG. 2, the method includes operations 201 and 202.

At operation 201, the computer device acquires, by using a voice registration module based on a first audio signal, a first hidden state corresponding to the voice registration module.

The first audio signal includes an audio signal from a registration sound source. The registration sound source may be the concerned sound source object, e.g., a target speaker. In the disclosure, the registration feature of the registration sound source may be acquired by using the voice registration module, so as to subsequently extract the audio signal of the registration sound source based on the registration feature, such as extracting the voice of the target speaker from a mixed voice signal.

It is to be noted that, in the application, the applicant has designed the technical concept of using the hidden state of the neural network as the registration feature. The hidden state may also be called an implicit expression which can represent the implicit feature of the audio signal. The registration feature may include the first hidden state corresponding to the voice registration module.

It is also to be noted that, in the application, the registration feature may be obtained by using audio with a shorter duration as compared to the related art. The first audio signal may be a signal with a preset duration. The preset duration is a shorter duration, for example, 0.5 s which is the shortest time to identify persons by sound. Of course, the preset duration may also be a shorter duration, for example, 0.51 s, 0.6 s, etc. The specific value of the preset shorter duration will not be limited in the application.

The voice registration module is used to provide the first hidden state corresponding to the first audio signal, and the first hidden state represents the implicit feature of the registration sound source in the first audio signal. Exemplarily, the first hidden state may include, but is not limited to, at least one of the following: the short-time expression, long-time expression and context feature of the first audio signal. The short-time expression and the long-time expression may represent the voice features of the registration sound source, such as the speaking feature of the target speaker. The short-time expression represents the features changing in a short time of the registration sound source in the audio signal. For example, the short-time expression may include pitch, timbre and other short-time features. The long-time expression represents the features changing in a long time of the registration sound source in the audio signal. For example, the long-time expression may include rhythm, pronunciation habit, intonation and other long-time features. The context feature may be some hidden layer states in hidden layers of the neural network, and represent the context information of the registration sound source in the first audio signal. The context feature is not related to the short-time, long-time and other voice features of the registration sound source. In the subsequence voice extraction process, the features of the target speaker in the mixed audio may be extracted by using the context feature.

The first hidden state is obtained during the feature extraction process of the first audio signal by using the voice registration module. Exemplarily, the computer device may model the audio feature of the first audio signal through the voice registration module and then use the hidden layer state parameter of the voice registration module as the first hidden state. At this step, the computer device may extract a first audio feature of the first audio signal by using the voice registration module, and then perform feature extraction on the first audio feature to obtain the first hidden state of the voice registration module during feature extraction.

In one possible implementation, the voice registration module includes a first encoding module and a hidden state analysis module; and, the computer device may acquire the first audio feature and the first hidden state by using the first encoding module and the hidden state analysis module, respectively. Exemplarily, the implementation of the operation 201 may include the following operations.

At a first operation, the computer device extracts the first audio feature of the first audio signal by using the first encoding module.

The first audio feature may represent a feature of the first audio signal in the frequency domain. In one possible example, the computer device may extract a frequency-domain feature of the first audio signal by using the first encoding module and then encode the frequency-domain feature to obtain the first audio feature. In another possible example, the first audio feature may also represent a feature of the first audio signal in the frequency domain and a feature of the first audio signal in the time domain. For example, the computer device may extract a frequency-domain feature and a time-domain feature of the first audio signal respectively by using the first encoding module and then encode the frequency-domain feature and the time-domain feature to obtain the first audio feature.

In one possible implementation, it is possible to perform time-frequency transform process on the first audio signal to obtain the frequency-domain feature and then directly encode the frequency-domain feature to obtain the first audio feature. In another possible implementation, it is also possible to perform encoding on the frequency-domain feature of the first audio signal by sub-band, and the first audio feature may include the audio feature of each sub-band. Correspondingly, the implementation of the first operation includes the following approaches 1 and 2.

Approach 1: the computer device may perform time-frequency transform process on the first audio signal by using the first encoding module to obtain the frequency-domain feature of the first audio signal; and, the computer device may also encode the frequency-domain feature to obtain the first audio feature.

Exemplarily, the frequency-domain feature may include the phase, amplitude or the like of the first audio signal in the frequency domain, and the computer device may further encode the phase, amplitude or other frequency-domain features into a higher-dimension first audio feature.

The time-frequency transform process may include framing and windowing, and short-time Fourier transform. The framing means that the first audio signal is divided into a plurality of frames. To realize smooth transition of the audio signal, there may be overlaps between frames. For example, based on the overall instability of the audio signal, the audio signal may be segmented for feature analysis, where each segment may be called a frame. For example, the frame length may be 10 ms, 30 ms, etc. If the overlap rate between frames is 50%, for example, then the first frame is from 0 ms to 10 ms, and the second frame is from 5 ms to 15 ms. The framing of the voice signal may be realized by weighting using a movable finite length window. The short-time Fourier transform (STFT) may be used to determine the frequency and phase of sine waves in local regions of the time-variant signal.

Exemplarily, by taking the first audio signal being a piece of audio having a sampling rate of 16k and a duration of n seconds as an example, the number L of sampling points included in the first audio signal is L=n*16000, that is, the first audio signal includes n*16000 sampling points. The first audio signal includes a plurality of frames, and each frame includes s_n sampling points. The s_n-point STFT is performed on the first audio signal, that is, the number of sampling points in each frame is s_n. If the overlap region between frames is s_n/2 (that is, the overlap rate between frames is 50%), after the STFT, the number of frames becomes k, and the k may be calculated by the following: k=L/(s_n/2)−1, where the number f of frequency points included in each frame may be represented as f=s_n/2. The number of frequency points in each frame is a half of the number of sampling points in each frame. Exemplarily, after the STFT, the frequency-domain feature of each frequency point includes a real part and an imaginary part, which may correspondingly describe the amplitude and phase of the audio signal. The frequency-domain feature of each frequency point included in the first audio signal is further encoded to obtain the first audio feature. For example, if the real part and the imaginary part are used to represent the frequency-domain feature of each frequency point, the dimension of the feature vector fₖ of the first audio feature may be expressed as [k, 2*f]. The feature vector fₖ includes the frequency-domain feature data of the real parts and imaginary parts of f frequency points included in each of k frames.

In the application, the first audio signal may be an audio signal in 0.5 s. By taking an audio signal having a duration of 0.5 s and 512 sampling points in each frame as an example, after the STFT is performed on the audio signal having a duration of 0.5 s and 512 sampling points in each frame, the number of frames in the first audio signal is 30, and the number of frequency points in each frame is 256. Thus, the frequency-domain feature of this first audio signal may be expressed as a feature vector fₖ, where k represents the frame number, and k={0, 1, 2, . . . , 29}; and, the dimension of the feature vector fₖ may be expressed as [30,256], that is, there are 30 frames and there are 256 frequency points in each frame. The feature vector may also be further encoded to obtain a higher-dimension feature vector. For example, the dimension of the encoded feature vector may be expressed as [256,30,256], where the first 256 means that each frequency point has 256 feature channels and the second 256 means that each frame has 256 frequency points.

If the first audio feature represents the features of the first audio signal in the frequency domain and the time domain, the computer device may also extract a time-domain feature of the first audio signal by using the first encoding module and then perform encoding based on the time-domain feature and the frequency-domain feature to obtain the first audio feature. For example, the encoded feature of the time-domain feature and the encoded feature of the frequency-domain feature may be stitched to obtain the first audio feature. For example, the time-domain feature of the first audio signal may be extracted by using a convolutional neural networks (CNN) network or other feature extraction networks.

Approach 2: the computer device performs time-frequency transform process on the first audio signal to obtain sub-band features corresponding to at least two preset frequency bands, and the computer device extracts, by using a first encoding module respectively corresponding to each preset frequency band based on the sub-band features of the preset frequency band, the first audio feature corresponding to the preset frequency band.

The computer device may perform time-frequency transform process on the first audio signal to obtain a frequency-domain feature of the first audio signal, and perform sub-band division on the first audio signal based on the frequency-domain feature and at least two preset frequency bands to obtain sub-band features corresponding to the at least two preset frequency bands. The first audio feature may include the audio features of sub-bands of each preset frequency band. Each preset frequency band respectively corresponds to a first encoding module; and, for each preset frequency band, the computer device may encode the sub-band features of the preset frequency band into a higher-dimension first audio feature by using the first encoding module corresponding to the preset frequency band.

The computer device may split, based on at least two preset frequency bands, the frequency-domain feature of the first audio signal into frequency-domain features of sub-bands corresponding to the at least two preset frequency bands. The implementation of the time-frequency transform process in the approach 2 may be the same as that of the time-frequency transform process in the approach and will not be repeated in the approach 2.

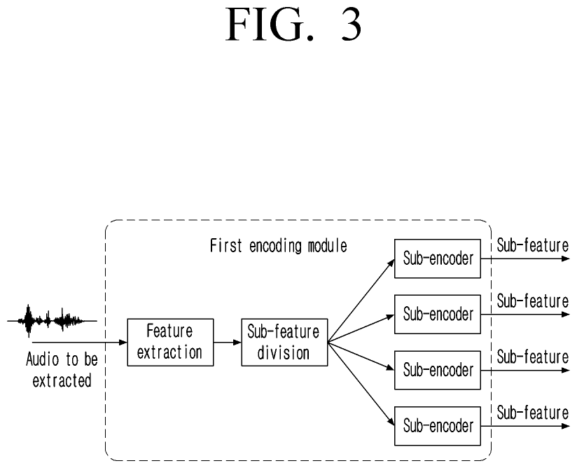

FIG. 3 is a schematic structure diagram of an encoder module according to an embodiment of the disclosure. Referring to FIG. 3, the first encoding module may be an encoder module including a plurality of sub-band encoders. The computer device may perform feature extraction on the first audio signal to be extracted by using the first encoding module, to obtain a frequency-domain feature of the first audio signal. Then, the computer device performs sub-feature division on the frequency-domain feature based on at least two preset frequency bands, to obtain frequency-domain features of a plurality of sub-bands. The encoder module may include a sub-encoder corresponding to each preset frequency band, and the computer device may further encode the frequency-domain features of sub-bands corresponding to each preset frequency band by using the sub-encoder corresponding to each preset frequency band, to obtain a higher-dimension sub-feature of each sub-band.

Exemplarily, in the application, a 16k frequency band may be divided into N sub-bands respectively corresponding to N preset frequency bands. As there are more divided sub-bands, the feature processing will be fine, however more sub-encoders will be introduced, and the model complexity will be higher. In the application, considering the performance and the model complexity comprehensively, the first audio signal may be divided into 4 to 6 sub-bands, and 4 to 6 encoders are correspondingly used for encoding to obtain audio features of the corresponding sub-bands.

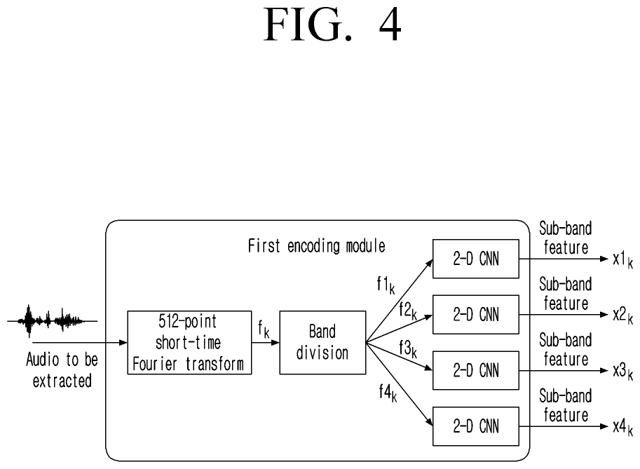

FIG. 4 is a schematic structure diagram of an encoder module according to an embodiment of the disclosure.

Referring to FIG. 4, in the application, the description is given by taking 4 sub-bands as an example. For the first audio signal, 512-point STFT is performed on the first audio signal to obtain a frequency-domain vector fₖ, and the frequency-domain feature of the first audio signal is divided into frequency-domain features corresponding to 4 sub-bands f1ₖ, f2ₖ, f3ₖ and f4ₖ according to the preconfigured 4 preset frequency bands. The k represents the frame number, the 4 preset frequency bands are 0-2k, 2k-4k, 4k-8k and 8k-16k, respectively, and the sub-band corresponding to each preset frequency band is f1ₖ, f2ₖ, f3ₖ and f4ₖ in turn. If each frame in the first audio signal includes 256 frequency points, that is, if the frequency-domain feature of each frame includes frequency-domain features of 256 frequency points, the 256 frequency points included in each frame are divided into 4 sub-bands, where the frequency points included in the sub-bands f1ₖ, f2ₖ, f3ₖ and f4ₖ are {1-32}, {33-64}, {65-128} and {129-256}, respectively. That is, the sub-bands f1ₖ contains 32 frequency points, the sub-band f2ₖ contains 32 frequency points, the sub-band f3ₖ contains 64 frequency points, and the sub-band f4ₖ contains 128 frequency points.

For example, for the first audio signal having a duration of 0.5 s and 512 sampling points in each frame, the dimension of the feature vector obtained according to the time-frequency transform process in the approach is [30,256]. Then, according to the 4 preconfigured preset frequency bands, the feature vector having a dimension of [30,256] is divided into feature vectors corresponding to 4 sub-bands. Since the sub-band encoding method is adopted subsequently, the full-band feature is divided into a plurality of sub-band features. The frequency-domain feature of the sub-band of each preset frequency band may be encoded by using the sub-encoder corresponding to each preset frequency band. The sub-band encoders may perform encoding in parallel. Thus, the complexity of the voice registration module is reduced, and the processing speed of the voice registration module is improved. If the number of the preset frequency bands is N, N sub-band encoders encode the frequency-domain features of the corresponding sub-bands in parallel. In addition, in the approach, if the first audio signal is not divided into sub-bands, only one encoder may be used to encode the full-band feature of the first audio signal into a higher-dimension first audio feature.

Referring to FIG. 4, by taking 4 sub-band encoders as an example, the first encoding module may be an encoder module including 4 sub-band encoders. Each sub-band encoder may be a CNN network based encoder, and may support a 2D convolution operation on the frequency domain features of sub-bands. The process of encoding the frequency-domain feature of each sub-band to obtain a corresponding higher-dimension feature vector will be described below.

For the sub-band f1ₖ, the process of calculating the feature vector x1ₖ of the corresponding first audio feature is as follows: the dimension of the frequency-domain feature vector of the sub-band f1ₖ is expanded from [30,64] to [1,1,30,64], a 2D convolution operation is performed on the expanded feature vector under an output channel of 256, a convolution kernel of 5*5 and a step of 1*1, and a feature vector x1ₖ of the audio feature of this sub-band f1ₖ is output, where the dimension of this feature vector is [1,256,30,64].

For the sub-band f2ₖ, the process of calculating the feature vector x2ₖ of the corresponding first audio feature is as follows: the dimension of the frequency-domain feature vector of the sub-band f2ₖ is expanded from [30,64] to [1,1,30,64], a 2D convolution operation is performed on the expanded feature vector under an output channel of 256, a convolution kernel of 5*5 and a step of 1*1, and a feature vector x2ₖ of the audio feature of this sub-band f2ₖ is obtained, where the dimension of this feature vector is [1,256,30,64].

For the sub-band f3ₖ, the process of calculating the feature vector x3ₖ of the corresponding first audio feature is as follows: the dimension of the frequency-domain feature vector of the sub-band f3ₖ is expanded from [30,128] to [1,1,30,128], a 2D convolution operation is performed on the expanded feature vector under an output channel of 256, a convolution kernel of 5*6 and a step of 1*2, and a feature vector x3ₖ of the audio feature of this sub-band f3ₖ is obtained, where the dimension of this feature vector is [1,256,30,64].

For the sub-band f4ₖ, the process of calculating the feature vector x4ₖ of the corresponding first audio feature is as follows: the dimension of the frequency-domain feature vector of the sub-band f4ₖ is expanded from [30,256] to [1,1,30,256], a 2D convolution operation is performed on the expanded feature vector under an output channel of 256, a convolution kernel of 5*6 and a step of 1*4, and a feature vector x4ₖ of the audio feature of this sub-band f4ₖ is obtained, where the dimension of this feature vector is [1,256,30,64].

After being encoded by each sub-band encoder, the dimension of the feature vector x1ₖ of each sub-band is [1,256,30,64], where the k represents the frame number and the i represents the i^{th} sub-band. The vector or feature mentioned later in the application may refer to the vector or feature of a certain sub-band.

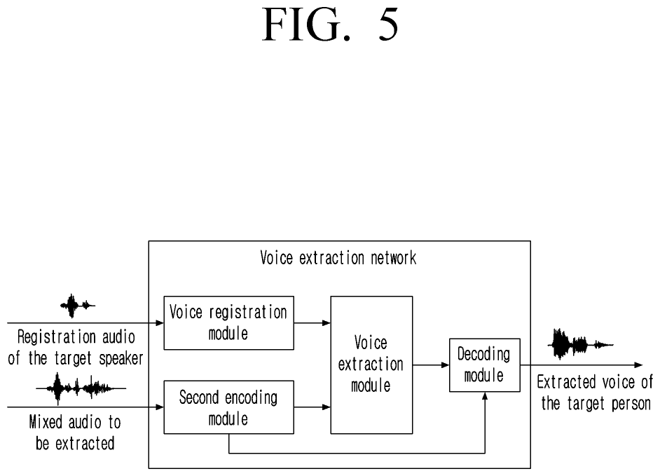

FIG. 5 is a schematic structure diagram of a voice extraction network according to an embodiment of the disclosure.

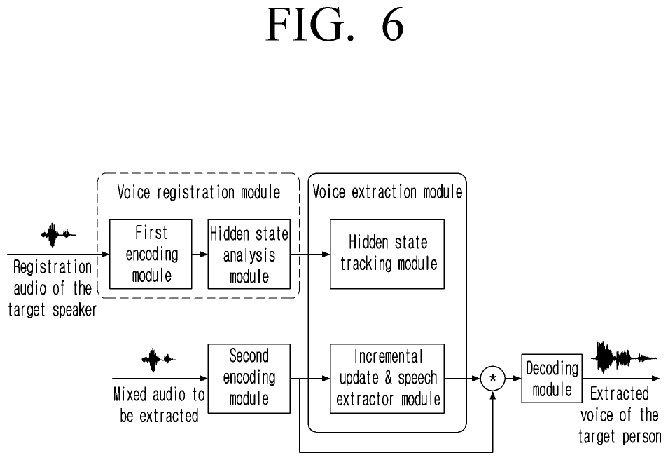

FIG. 6 is a schematic structure diagram of a voice extraction network according to an embodiment of the disclosure.

The audio signal processing method of the application may be realized by an audio processing model. Referring to FIG. 5, by taking voice extraction as an example, the audio processing model may be a network that supports voice extraction. The voice extraction network may include 4 parts, i.e., a second encoding module, a voice registration module, a voice extraction module and a decoding module. The voice registration module may be configured to process a first audio signal to obtain a first hidden state. Referring to FIG. 6, the voice registration module may include a first encoding module and a hidden state analysis module. The first encoding module may be configured to perform time-frequency transform process on the input first audio signal to obtain a frequency-domain feature and encode the frequency-domain feature into a first audio feature that can represent more dimensions. By performing a time-frequency transform process on the first audio signal by using the first encoding module to obtain the feature of the first audio signal in the frequency domain, it is advantageous for the model to model and learn the input signal. In the application, the implementation of the first encoding module will be described by taking STFT as an example. Of course, other feature extraction methods may also be used. For example, feature extraction is performed by using a CNN network. The specific way of the time-frequency transform process will not be limited in the application.

For the case where the first audio feature represents the features of the first audio signal in the frequency domain and the time domain, the computer device may also extract a time-domain feature of the first audio signal by using the first encoding module, then encode the time-domain feature, and obtain the first audio feature based on the encoded feature of the time-domain feature and the encoded feature of the frequency-domain feature of each sub-band. For example, the encoded feature of the frequency-domain feature of each sub-band is stitched with the encoded feature of the time-domain feature respectively to obtain the first audio feature of each sub-band.

The computer device performs, by using the hidden state analysis module based on the first audio feature, feature extraction to acquire a first hidden state of the hidden state analysis module during feature extraction.

The hidden state analysis module includes at least one of the following: a recurrent neural network, an attention network, a transformer network and a convolutional network. Feature extraction is performed based on the first audio feature by using the hidden state analysis module, that is, the hidden state analysis module performs feature modeling on the first audio signal. After the modeling is completed, the computer device may acquire the hidden layer state parameter of the hidden state analysis module as the first hidden state.

The first audio signal includes a plurality of frames. Feature extraction may be performed on a frame by frame basis by using the hidden state analysis module, and the first hidden state of the hidden state analysis module may be updated during feature extraction in a frame-by-frame iteration manner. Exemplarily, for each frame in the first audio signal, the computer device may successively perform the following: the computer device performs, by using the hidden state analysis module based on the first audio feature of the current frame, feature extraction to acquire a first hidden state of the hidden state analysis module during feature extraction, and updates the first hidden state of the hidden state analysis module based on the acquired first hidden state.

In one possible implementation, it is possible to perform feature extraction on a frame by frame basis in a sequential order of frames and then update the first hidden state. The operation may be implemented by the following step D1.

At step D1, for each frame in the first audio signal, the following is successively performed based on a sequential order of frames: performing, by using the hidden state analysis module based on a first hidden state corresponding to a frame preceding the current frame and the first audio feature of the current frame, feature extraction to acquire a first hidden state corresponding to the hidden state analysis module at the current frame during feature extraction, and updating the first hidden state of the hidden state analysis mode based on the acquired first hidden state.

The order may represent the order of frames in the audio signal. For example, for a period of 0.5 s voice, the first frame may be a frame corresponding to the 0^{th} ms (Oms-10 ms), the second frame may be a frame corresponding to the 5^{th} ms, the third frame may be a frame corresponding to the 10^{th} ms . . . and the last frame may be a frame corresponding to the 25^{th} ms. The sequential order means that the order of frames along the time axis of the audio signal in which the smaller the order of a frame, the earlier the position of the frame in this period of 0.5 s voice is.

Exemplarily, the computer device may perform feature extraction on the first audio feature of the first frame by using the hidden state analysis module, acquires the first hidden state of the hidden state analysis module during feature extraction, and updates the hidden layer state of the hidden state analysis module as the first hidden state corresponding to the first frame. Therefore, during the feature extraction with the second audio feature of the second frame, the hidden state analysis module is used to perform feature extraction on the first audio feature of the second frame based on the first hidden state corresponding to the first frame; and, to acquire the first hidden state of the hidden state analysis module during feature extraction. Of course, it is also possible to update the hidden layer state of the hidden state analysis module as the first hidden state corresponding to the second frame. Such a cycle is repeated until the first hidden state during the feature extraction of the first audio feature of the preset frame is acquired. The computer device may obtain a registration feature of the first audio signal based on the first hidden state corresponding to the preset frame. The preset frame may include at least one frame. For example, when the preset frame includes one frame (e.g., the last frame, the penultimate frame, the antepenultimate frame or the like in the first audio signal), the computer device may use the first hidden state corresponding to the preset frame as the registration feature of the first audio signal. Alternatively, when the preset frame includes at least two frames (e.g., the last two frames, the last three frames, etc. in the first audio signal), the computer device may use the average or sum of the first hidden states respectively corresponding to the at least two frames as the registration feature of the first audio signal.

In another possible implementation, it is possible to perform feature extraction based on an inverse order of frames and update the first hidden state. The operation may be implemented by the following step D2.

At step D2, for each frame in the first audio signal, the following is successively performed based on an inverse order of frames: performing, by using the hidden state analysis module based on a first hidden state corresponding to a frame subsequent to the current frame and the first audio feature of the current frame to acquire a first hidden state corresponding to the hidden state analysis module at the current frame during feature extraction, and updating the first hidden state of the hidden state analysis mode based on the acquired first hidden state.

The inverse order means the order opposite to the time axis of the audio signal, for example, in a period of 0.5 s voice, the last frame, the second last frame, . . . , the second frame and the first frame may be processed successively.

Exemplarily, for a process in the inverse order, the hidden state analysis module may be used to perform feature extraction of the first audio feature of the last frame and to acquire the first hidden state of the hidden state analysis module during feature extraction, and to update the hidden layer state of the hidden state analysis module as the first hidden state corresponding to the last frame. Therefore, during the feature extraction of the second audio feature of the second last frame, the hidden state analysis module may be used to perform feature extraction of the first audio feature of the second last frame based on the first hidden state corresponding to the last frame; and, to acquire the first hidden state of the hidden state analysis module during feature extraction, and to update the hidden layer state of the hidden state analysis module as the first hidden state corresponding to the second last frame. Such a cycle is repeated until the first hidden state during the feature extraction of the first audio feature of the preset frame is acquired. The preset frame may be one frame or at least two frames, for example, the first frame, the first two frames, the first three frames or the like in the first audio signal.

In another possible implementation, it is possible to combine the implementations corresponding to the sequential order and the inverse order. For example, during the frame-by-frame feature extraction in the sequential order, the hidden state analysis module used correspondingly may be referred to as a sequential hidden state analysis module, and the obtained first hidden state may be referred to as a first sequential hidden state. During the frame-by-frame feature extraction in the inverse order, the hidden state analysis mode used correspondingly may be referred to as a reverse hidden state analysis mode, and the obtained first hidden state may be referred to as a first reverse hidden state. When the implementations in the sequential order and the inverse order are combined, for each frame in the first audio signal, the process of the step D1 may be executed by using the sequential hidden state analysis module to obtain the first sequential hidden state, and the process of the step D2 is executed by using the reverse hidden state analysis module to obtain the first reverse hidden state.

In one possible embodiment, the computer device may perform feature analysis on the first audio feature and then perform feature extraction based on the feature analysis vector obtained after the feature analysis to obtain the first hidden state. An implementation may include the following operations.

Ata first operation, the computer device acquires, by using the hidden state analysis module based on at least one feature analysis mode, at least one feature analysis vector of the first audio feature.

The at least one feature analysis mode may include at least one of intra-frame analysis or inter-frame analysis. If the at least one feature analysis mode includes intra-frame analysis, an intra-frame analysis vector of the first audio feature may be obtained based on the intra-frame analysis. The intra-frame analysis vector is used to analyze the frequency-domain change characteristic of each frequency point in the same frame in the first audio signal. If the at least one feature analysis mode includes inter-frame analysis, an inter-frame analysis vector of the first audio feature may be obtained based on the inter-frame analysis. The inter-frame analysis vector is used to analyze the time-varying characteristic of each frequency point of the same frequency between different frames in the first audio signal.

In one possible implementation, it is possible to perform dimension reduction on the feature vector of the first audio feature and then perform feature analysis. For example, for a first audio feature vector x1ₖ of a certain sub-band, the dimension is [256,499*64], and a 1D convolution operation is performed to obtain a new vector s_intput [64, 499*64]. The feature dimension is reduced from 256 to 64. Thus, by performing dimension reduction on the feature vector, the complexity of the model is reduced, and the processing efficiency of the audio signal is improved.

The intra-frame analysis may be a way to scan the first audio feature along the frequency path to obtain the first audio features of all frequency points in each frame. Exemplarily, the intra-frame analysis may be performed by transverse local cutting. The transverse local cutting is to perform scanning in the frequency path in the transverse direction (frequency direction), and the vector obtained by scanning may be expressed as v_local.

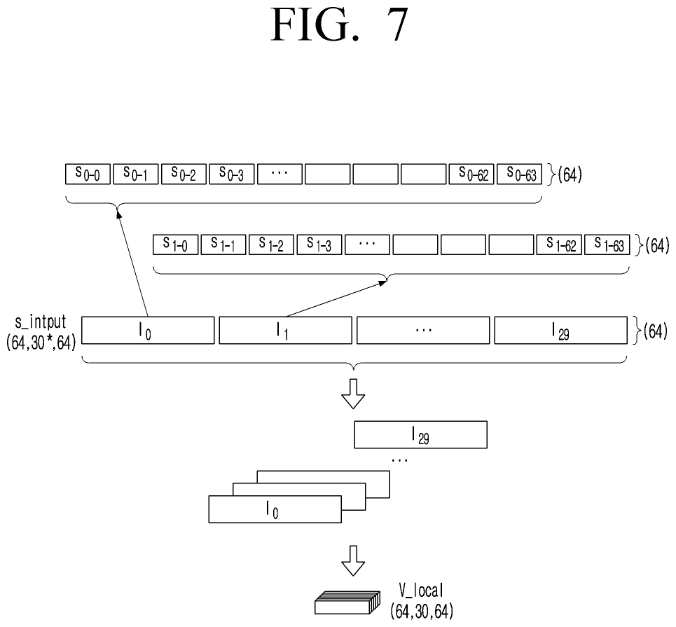

FIG. 7 shows a cutting process of a Local cutting mode according to an embodiment of the disclosure.

Referring to FIG. 7, the feature vector of the input first audio feature may be expressed as s_intput, and the dimension of the feature vector may be [64,30*64], indicating that the first audio signal includes 30 frames, each frame includes 64 frequency points and each frequency point corresponds to the feature values at 64 feature channels. The feature vector having a dimension of [64,30*64] is cut and rearranged into a 3D vector in unit of frame. The l₀, l₁, . . . , l₂₉ represent the feature data of 30 frames, i.e., the 0^{th} frame, the 1^{st} frame, . . . , the 29^{th} frame respectively. The data of each frame contains 64 frequency features. For example, l₀ contains the first audio features {s₀₋₀, s₀₋₁, s₀₋₂ . . . s₀₋₆₃} of 64 frequency points of the 0^{th} frame. The dimension of the 3D vector v_local obtained by cutting the data of 30 frames is [64,30,64], indicating the feature values at 64 feature channels for each of 64 frequency points included in each frame.

It is to be noted that, when the intra-frame analysis mode is adopted, the intra-frame analysis vector is input into the hidden state analysis module on a frame by frame basis, all frequency points (from the first frequency point to the last frequency point) in one frame may be modeled by the hidden state analysis mode, and the frequency-domain change characteristic between various frequency points included in each frame is analyzed to obtain the relationship among the frequency points in the frame.

The inter-frame analysis may be a way to scan the first audio feature along the time path to obtain the first audio features of frequency points of the same frequency component between frames. Exemplarily, the inter-frame analysis may be performed by longitudinal global cutting. The longitudinal global cutting is to perform scanning in the time path in the longitudinal direction (time direction), and the vector obtained by scanning may be expressed as v_global.

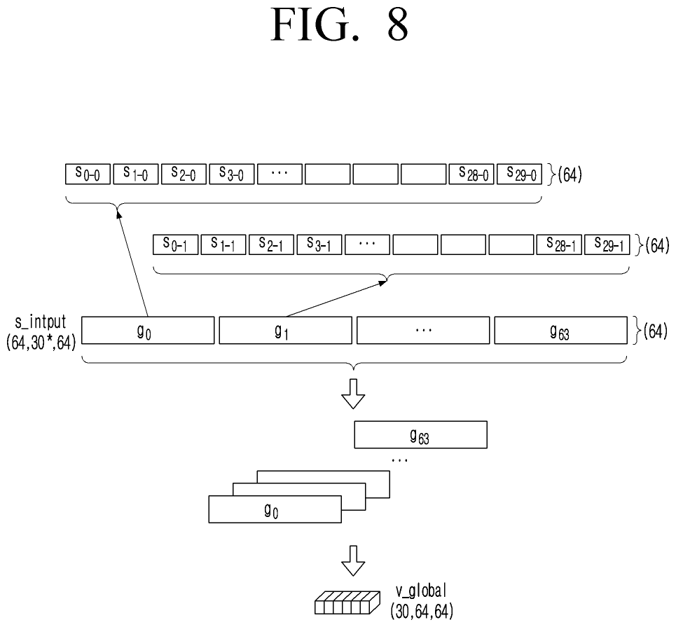

FIG. 8 shows a cutting process of a Global cutting mode according to an embodiment of the disclosure.

Referring to FIG. 8, for the input feature vector s_intput, the feature vector having a dimension of [64,30*64] is cut and rearranged into a 3D vector in unit of frame. The g₀, g₁, . . . g₆₃ represents the feature data of 64 blocks in total, and the data of each block contains the first audio feature of each frame at a certain frequency point. For example, g₀ contains the first audio feature {s₀₋₀, s₁₋₀, s₂₋₀ . . . s₂₉₋₀} of the 0^{th} frequency point of each frame in the 30 frames, where s₀₋₀, s₁₋₀, s₂₋₀, . . . , s₂₉₋₀ represent the first audio features of the respective 0^{th} frequency points of the 0^{th} frame, the 1^{st} frame, the 2^{nd} frame . . . the 29^{th} frame, respectively. The dimension of the 3D vector v_global obtained by cutting the data of the 30 frames is [30,64,64], indicating the first audio features of 30 frames at each of the 64 frequency points.

It is to be noted that, when the intra-frame analysis mode is adopted, the inter-frame analysis vector is input into the neural network on a frame by frame basis, and the neural network can model the same frequency point of continuous frames along the time axis to analyze the time-domain change characteristic of each frequency point along the time axis to obtain the relationship among frames.

At a second operation, the computer device performs, by using the hidden state analysis mode based on the at least one feature analysis vector, feature extraction to obtain the first hidden state of the hidden state analysis module during the feature extraction based on the at least one feature analysis vector.

The hidden state analysis module may include at least one core network, and one core network corresponds to one feature analysis vector. That is, each core network is configured to perform feature extraction based on one corresponding feature analysis vector.

In one possible implementation, based on the feature extraction process of each feature analysis vector, the respective first hidden states of two core networks during the feature extraction based on the corresponding feature analysis vectors are acquired. For each feature analysis vector, the corresponding core network may be used by the computer device to perform feature extraction based on this feature analysis vector and acquire the first hidden state of the core network during feature extraction. This first hidden state includes a hidden state when feature extraction is performed based on the intra-frame analysis vector by using the first core network, and a hidden state when feature extraction is performed based on the inter-frame analysis vector by using the second core network.

In another possible implementation, the hidden state when feature extraction is performed based on the inter-frame analysis vector by using the second core network may be acquired based on the feature extraction process of each feature analysis vector, that is, the first hidden state includes the hidden state when feature extraction is performed based on the inter-frame analysis vector by using the second core network. For example, feature extraction may be performed on each frame in the first audio signal by using the first core network based on the intra-frame analysis vector to obtain an intra-frame feature of the first audio signal; and, an inter-frame analysis vector is obtained based on the intra-frame feature, and feature extraction is performed based on the intra-frame analysis vector by using the second core network to acquire a first hidden state of the second core network during feature extraction. The inter-frame analysis vector may be obtained by performing Global cutting on the intra-frame feature.

Exemplarily, if the first audio signal is divided into sub-bands of at least two preset frequency bands and each sub-band may correspond to at least one feature analysis vector, the same feature analysis vector of each sub-band may be subjected to feature extraction by using a core network corresponding to this feature analysis vector. For each sub-band, the first hidden state corresponding to each feature analysis vector of this sub-band may be obtained. The first hidden state corresponding to each feature analysis vector of each sub-band may include, but not limited to: the short-time expression, long-time expression and context feature of this sub-band.

In one possible implementation, the first audio signal includes a plurality of frames, and the feature extraction may be performed and the first hidden state may be updated in a frame-by-frame iteration manner. The implementation of the second operation may include the following: for each feature analysis vector, the corresponding core network in the hidden state analysis module is used by the computer device to perform feature extraction based on each feature analysis vector of at least one frame included in the first audio signal and acquire the first hidden state of the corresponding core network during the feature extraction based on each feature analysis vector, in a frame-by-frame iteration manner. The first audio signal includes N frames, where N is a positive integer, and 0<i≤N. For each feature analysis vector, the frame-by-frame iteration manner includes the following: feature extraction is performed on this feature analysis vector of the (i+1)^{th} frame by using the corresponding core network in the hidden state analysis module based on the first hidden state corresponding to the i^{th} frame and this feature analysis vector of the (i+1)^{th} frame, and the first hidden state of this core network during the feature extraction of this feature analysis vector of the (i+1)^{th} frame, until the first hidden state corresponding to the preset frame is obtained. For example, the preset frame may be one or more of the Nth frame, the (N−1)^{th} frame, the (N−2)^{th} frame, etc.

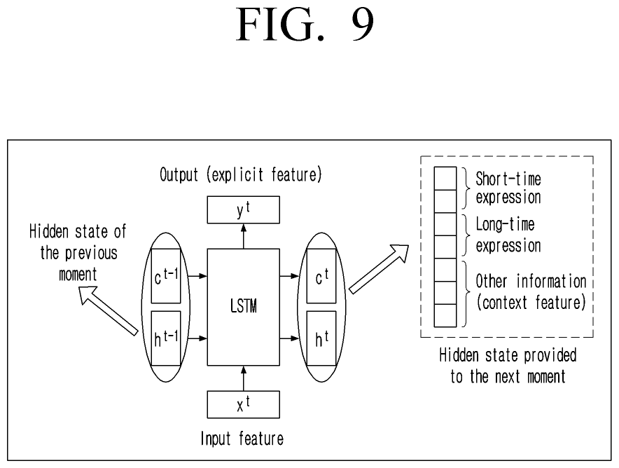

FIG. 9 is a schematic diagram of a core network of a hidden state analysis module according to an embodiment of the disclosure.

Referring to FIG. 9, the core network of the hidden state analysis module may be a long short term memory network (LSTM). The LSTM network may perform modeling based on the feature x^{t} of the current moment and the first hidden state c^{t-1} and h^{t-1} of the previous moment, and outputs an explicit feature expression y^{t} of the current moment and provides it to the hidden states c^{t} and h^{t} of the next moment, so that the first hidden state of each moment can be iteratively updated. The first hidden state includes short-time expression, long-time expression and other information, and the other information may be a context feature.

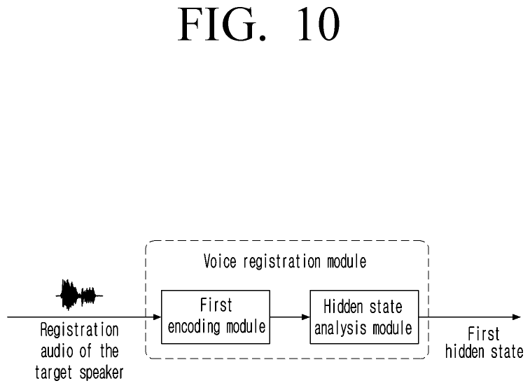

FIG. 10 is a schematic structure diagram of a voice registration module according to an embodiment of the disclosure.

Referring to FIG. 10, the voice registration module in the audio processing model may include a first encoding module and a hidden state analysis module. The registration audio of the target speaker is input into an encoder module, and a first audio feature is acquired by the first encoding module. The operation is implemented by the hidden state analysis module to obtain a registration feature (i.e., first hidden state) of the registration sound source.

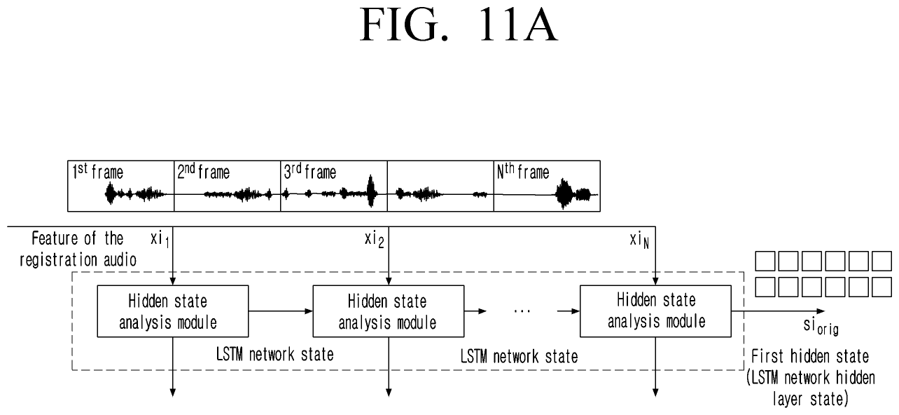

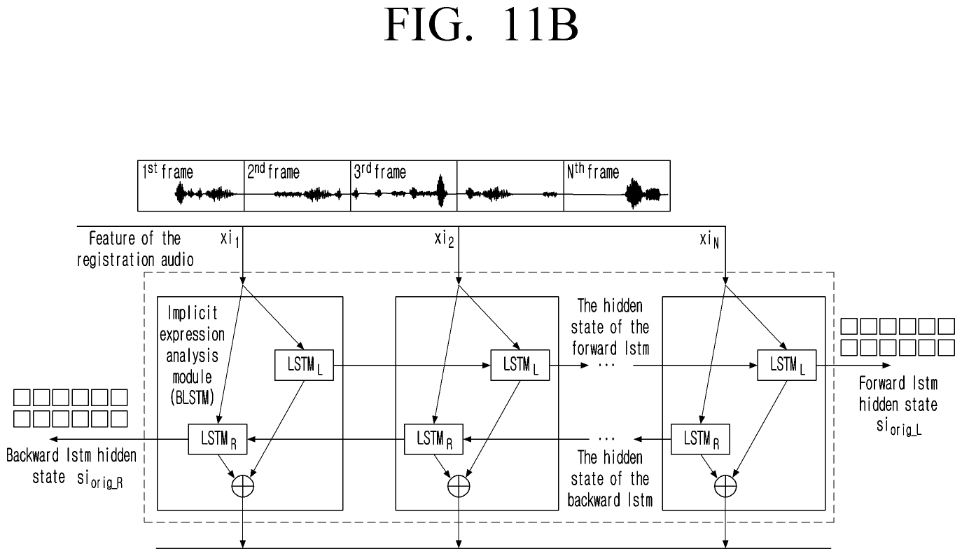

FIG. 11A is a timing flowchart of a hidden state analysis module according to an embodiment of the disclosure.

Referring to FIG. 11A, the first audio signal may be input into the hidden state analysis module on a frame by frame basis for modeling. For example, the registration audio signal of the target speaker is divided into a plurality of sub-bands, wherein the first audio feature of each frame of the i^{th} sub-band is xi₁, xi₂, . . . xi_{N}, respectively. The first audio feature of each frame is input into the hidden state analysis module, and the hidden state analysis module may perform feature extraction on the first audio feature of the current frame based on the first hidden state corresponding to the previous frame. In this way, frame-by-frame iteration is realized. When the feature extraction of the last frame is completed, the first hidden state of the hidden state analysis module when the feature extraction of the last frame is completed is used as the registration feature of the target speaker. It is to be noted, feature extraction is performed on the first audio feature by using the hidden state analysis module, the output of the hidden state analysis module is an explicit feature of the feature extraction, and the output of this module may be used in the training stage. For example, in the training stage, the hidden state analysis module may be iteratively trained by using the explicit feature output by the hidden state analysis module. In the stage of performing voice extraction by using the trained hidden state analysis module, the first hidden state corresponding to the hidden state analysis module may be used.

FIG. 11B is a timing flowchart of another hidden state analysis module according to an embodiment of the disclosure.

Referring to FIG. 11B, the core network of the hidden state analysis module may also be a directional long short-term memory network (BLSTM, which is a long short-term memory network combined by a forward LSTM and a backward LSTM). The sequential hidden state analysis module may be implemented by the forward LSTM (which may be represented by LSTM_{L}), and the reverse hidden state analysis module may be implemented by the backward LSTM (which may be represented by LSTM_{R}). The forward LSTM_{L} starts frame-by-frame processing from the first frame until all frames are processed, so that the first sequential hidden state corresponding to the forward LSTM_{L} will be obtained. The first sequential hidden state is correspondingly expressed as a hidden state si_{orig_L}. The backward LSTM_{R} starts frame-by-frame processing from the last frame until the first frame is processed, so that the first reverse hidden state corresponding to the backward LSTM_{R} will be obtained. The first reverse hidden state is correspondingly expressed as a hidden state si_{orig_R}. The two hidden states constitute a vector expression of the target speaker output by an implicit expression analysis module in the voice registration module. The vector expression is correspondingly expressed as si_{orig}=[si_{orig}_{_{L}}, si_{orig_R}]. It is to be noted that, in the training state, training may be performed by using the sequential explicit feature of feature extraction output by the sequential hidden state analysis module and the reverse explicit feature of feature extraction output by the reverse hidden state analysis module. For example, feature fusion is performed on the sequential explicit feature and the reverse explicit feature corresponding to the first frame, and the model is then trained by using the fused feature.

In one possible implementation, the computer device may perform feature extraction on the inter-frame analysis vector and the intra-frame analysis vector by using a first core network and a second core network, respectively. Exemplarily, the first core network and the second core network may be connected in series. The computer device may first perform intra-frame analysis on the first audio feature and input the intra-frame analysis vector into the first core network for feature extraction; and, then output first explicit feature and acquire a first hidden state of the first core network during the feature extraction of the intra-frame analysis vector. Then, the computer device may also perform inter-frame analysis on the first explicit feature to obtain an inter-frame analysis vector, input the inter-frame analysis vector into the second core network for feature extraction, and acquire a first hidden state of the second core network during the feature extraction of the inter-frame analysis vector.

Exemplarily, the first core network may include a plurality of neurons. Each neuron may be configured to perform feature extraction on the first audio features of all frequency points in each frame. Each neuron may perform feature modeling on all frequency points in the frame. For the intra-frame analysis vector of the current frame, the computer device may successively perform feature extraction based on the intra-frame analysis vector by using each neuron, and acquire the first hidden state of the first core network during the feature extraction of the intra-frame analysis vector. The computer device may also update the first hidden state of the first core network based on the acquired first hidden state. For example, the computer device may also perform feature extraction based on the first hidden state corresponding to the current frame and the intra-frame analysis vector of the next frame by using each neuron, i.e., performing feature modeling on the intra-frame analysis vector by using the state corresponding to the current frame; and, acquire a first hidden state corresponding to the next frame. Such a cycle is repeated until the hidden state corresponding to the preset frame is obtained.

It is to be noted that, in the first core network, each neuron may perform feature extraction on each frequency point in one frame based on the intra-frame analysis vector, so that the relationship among frequency points in one frame (i.e., the change characteristic of each frequency point in the frame in the frequency domain) can be effectively analyzed.

Exemplarily, the second core network may include a plurality of neurons, each neuron corresponds to specified frequency points of each frame, and the plurality of neurons may process the respective specified frequency points in parallel. In one possible example, each neuron may correspond to frequency points with the same frequency of frames, that is, each neuron is configured to analyze the change characteristic in time among frequency points with the same frequency of frames. Each neuron corresponds to a group of specified frequency points in each frame, and a group of frequency points includes at least one frequency point. For example, the first neuron specifically analyzes the relationship among 0^{th} groups of frequency points in 30 frames. For example, the 0^{th} group of frequency points in each frame includes the 0^{th} frequency point to the 9^{th} frequency in this frame. That is, the first neuron may specifically analyze the relationship among 30 0^{th} groups of frequency points. The second neuron specifically analyzes the relationship among 1^{st} groups of frequency points in 30 frames. For example, the 1^{st} group of frequency points in each frame includes the 10^{th} frequency point to the 19^{th} frequency point. The 2^{nd} neuron may specifically analyze the relationship among 30 1^{st} groups of frequency points. Exemplarily, for the inter-frame analysis vector of the current frame, each neuron of the second core network is used by the computer device to perform feature extraction based on the feature vector of the specified frequency point corresponding to the neuron in the current frame, so that feature extraction is perform on a plurality of frequency points in the current frame by using a plurality of neurons; and, to acquire the first hidden state of each neuron during the feature extraction of the current frame. Each neuron is used by the computer device to perform feature extraction based on the first hidden state of each neuron during the feature extraction of the current frame and the inter-frame analysis vector of the next frame, to obtain a first hidden state corresponding to the next frame. Such a cycle is repeated in the frame-by-frame iteration manner until the first hidden state of the preset frame is obtained.

It is to be noted that, in the second core network, each neuron may be a dedicated neuron for frequency points with the same frequency between frames, and the frames are obtained by framing the first audio signal in continuous time. Therefore, feature extraction is performed by using the second core network based on the inter-frame analysis vector, so that the time-domain change characteristic of frequency points with the same frequency between frames (i.e., the change of different frequency components of the first audio signal over time) is effectively analyzed by the second core network.

By acquiring the first hidden state of the first core network during the analysis of the frequency-domain change characteristic of the frequency points in the frame and acquiring the first hidden state of the second core network during the analysis of the time-domain change characteristic, attention is paid not to the frequency-domain change of frequency points in the frame, but also to the time-domain change between frames. By using the first hidden states respectively corresponding to the first core network and the second core network as the registration features, the registration features can more effectively and accurately represent the implicit feature of the first audio signal, so that the accuracy and effectiveness of the registration process are improved and the accuracy of subsequent audio signal extraction is improved.

In one possible example, it is also possible to alternately use the two feature analysis feature vectors for modeling. For example, the computer device performs feature extraction on the inter-frame analysis vector by using the second core network and acquires a second explicit feature output by the second core network. The computer device may perform intra-frame analysis on the second explicit feature to acquire an intra-frame analysis vector, input the intra-frame analysis vector into the first core network, repeatedly execute, based on the intra-frame analysis vector, the process of performing feature extraction by using the first core network based on the intra-frame analysis vector and performing feature extraction by using the second core network based on the inter-frame analysis vector until the ending condition is satisfied, and use the first hidden state corresponding to the last frame during the last modeling as the registration feature. The ending condition may include, but is not limited to, the following: the number of cycles exceeds a target number threshold; the consumed time exceeds a target time threshold; the data distribution of the first hidden state satisfies a preconfigured condition; etc. For example, for the same frame, feature extraction may be repeated for 3 to 6 times by the first core network and the second core network. For example, the hidden state in the sixth repeated execution is used as the first hidden state corresponding to this frame.

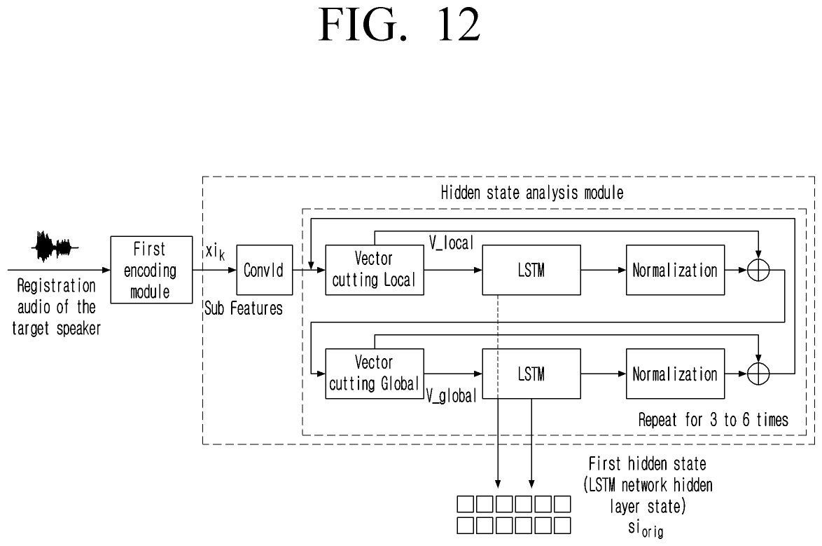

FIG. 12 is a schematic diagram of a network structure of a voice registration module according to an embodiment of the disclosure.

Referring to FIG. 12, a first audio feature of the registration audio of the target speaker may be extracted by using the first encoding module in the voice registration module. For example, first audio features of sub-bands of each preset frequency band are acquired by sub-band encoding, so that a plurality of sub-features corresponding to a plurality of sub-bands are obtained. In addition, feature extraction is performed based on the first audio feature of each sub-band to obtain a first hidden state corresponding to each sub-band. Referring to FIG. 12, for each frame, the process of acquiring the first hidden state corresponding to this frame based on the first audio feature may include the following steps S1 to S9.

At step S1, for the first audio feature xiₖ of the k^{th} frame in the i^{th} sub-band, the feature dimension of the first audio feature is reduced by a 1D convolution (Conv1d) operation.

At step S2, the first audio feature is input into the hidden state analysis module, and intra-frame analysis is performed on the first audio feature in the hidden state analysis module to obtain an intra-frame analysis vector V_local.

At step S3, the intra-frame analysis vector is input into a first LSTM network (first core network) on a frame by frame basis for feature extraction to obtain a first feature vector and a first hidden state of the first LSTM network during the feature extraction.

At step S4, the first feature vector is normalized to obtain a second feature vector.

At step S5, the second feature vector and the intra-frame analysis vector are stitched to obtain a third feature vector, and inter-frame analysis is performed on the third feature vector to obtain an inter-frame analysis vector V_global.

At step S6, the inter-frame analysis vector is input into a second LSTM network (second core network) on a frame by frame basis for feature extraction to obtain a fourth feature vector, and the fourth feature vector is normalized to obtain a fifth feature vector.

At step S7, the fifth feature vector and the inter-frame analysis vector are stitched to obtain a sixth feature vector, and intra-frame analysis is performed on the sixth feature vector to obtain an intra-frame analysis vector again.

At step S8, the intra-frame analysis vector obtained at the step S7 is input into the first core network again on a frame by frame basis to repeatedly execute the steps S3 to S7.

By repeatedly executing the process of feature extraction, acquiring the first hidden state and normalization by using two core networks, the alternate modeling of the intra-frame analysis vector and the inter-frame analysis vector is realized.

At step S9, each frame may be repeatedly input into the two core networks for 3 to 6 times to obtain the first hidden state corresponding to this frame.

For each frame, the above steps S1 to S9 are executed to obtain the first hidden state corresponding to each frame, and the first hidden state of the hidden state analysis module is iteratively updated on a frame by frame basis during the feature extraction based on the first audio feature of the next frame. When the feature modeling of all frames is completed by two core networks, the first hidden states si_{orig} of the two core networks are acquired, where i represents the i^{th} sub-band.

In one example, s i_{orig}=[si_{orig-local},si_{orig-global}], where si_{orig-local} represents the network hidden state of the final moment of the first LSTM that processes the vector v_local, and si_{orig-global} represents the network hidden state of the final moment of the second LSTM that processes the vector v_global.

In one possible implementation, the combination mode will be described by taking FIG. 11B as an example. Correspondingly, in FIG. 11B, s i_{orig_L} [si_{orig_local_L},si_{orig_global_L}], where si_{orig_local_L} represents the network hidden state of the forward LSTM_{L} in the first BLSTM that processes the intra-frame analysis vector v_local, and may be the first sequential hidden state during the feature extraction based on the intra-frame analysis vector of the last frame; and, si_{orig_global_L} represents the network hidden state of the forward LSTM_{L} in the second BLSTM that processes the inter-frame analysis vector v_global, and may be the first sequential hidden state during the feature extraction based on the inter-frame analysis vector of the last frame.

In FIG. 11B, the backward LSTM_{R} starts processing from the last frame until the first frame is processed, so that the first reverse hidden state will be obtained. Thus, si_{orig_R}=[si_{orig_local_R},si_{orig_global_R}], where si_{orig_local_R} represents the first reverse hidden state of the backward LSTM_{R} in the first BLSTM that processes the infra-frame analysis vector v_local, for example, the network hidden state during the feature extraction based on the intra-frame analysis vector of the first frame; and, si_{orig_global_R} represents the first reverse hidden state of the backward LSTM_{R} in the second BLSTM that processes the inter-frame analysis vector v_global, for example, the network hidden state during the feature extraction based on the inter-frame analysis vector of the first frame. The two hidden states constitute the first hidden state of the target speaker output by the implicit expression analysis module. That is, the final first hidden state may b″ expressed as: s i_{orig}=[si_{orig_L},si_{orig_R}][si_{orig_local_L},si_{orig_global_L},si_{orig_local_R},si_{orig_global_R}].

In the above, the hidden states of two LSTM networks or two BLSTM networks are used as the final first hidden state si_{orig}. However, in another possible implementation, for example, in practical applications, it is also possible to use only the second LSTM network. In other words, in the network structure diagram shown in FIG. 11B, the network hidden state of the LSTM network that processes the vector v_global is used as the first hidden state, that is, si_{orig}=[si_{orig-global}]. Similarly, it is also possible to use only the hidden state of the second BLSTM network as the output si_{orig}=[si_{orig_global_L},si_{orig_global_R}] of this module.

As shown in FIG. 5, the voice extraction network further includes a voice extraction module. The first hidden states si_{orig} of the two core networks in the voice registration module may be output to the voice extraction module, and the first hidden states s i_{orig} are used as the initial hidden state of the voice extraction module. Subsequently, the target audio signal may be extracted from the second audio signal by using the voice extraction module and the decoding module.

It is to be noted that the voice extraction module includes an incremental update & speech extractor module. The incremental update & speech extractor module may also include a core network. The core network in the incremental update & speech extractor module has the same network structure as the core network in the hidden state analysis module, so the hidden state of the core network in the incremental update & speech extractor module may be initialized by using the first hidden state si_{orig} of the core network in the hidden state analysis module. It is to be noted that, in the embodiments of the application, the description is given only by taking the core network being an LSTM network as an example. The LSTM network is a time recurrent neural network. The core network may also be other recurrent neural networks or other types of neural networks, for example recurrent neural networks (RNNs), attention networks, transformer networks, convolutional networks, etc. The core network used by the hidden state analysis module will not be limited in the application.

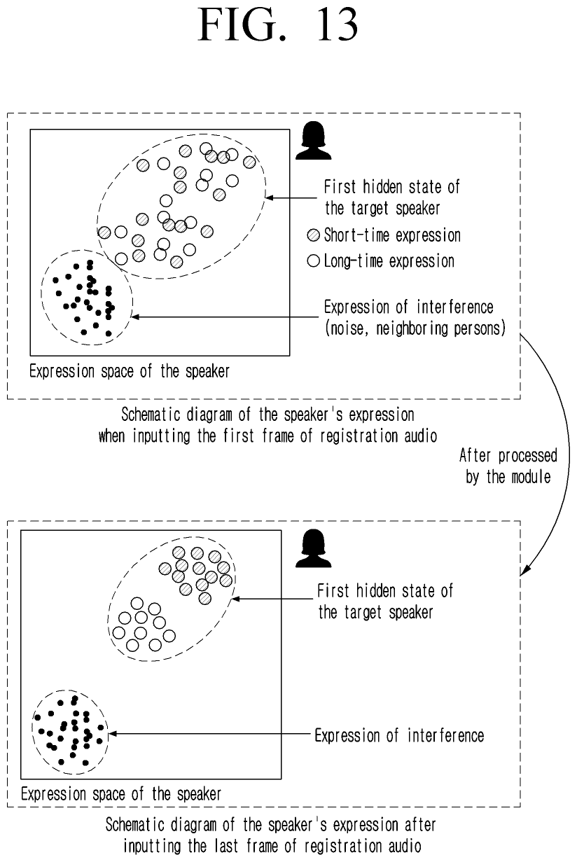

FIG. 13 is a schematic diagram of hidden state distribution updating according to an embodiment of the disclosure.

Referring to FIG. 13, FIG. 13 shows the first hidden states corresponding to the first frame and the last frame of a certain sub-band. The black dots represent the expression of interference, and belong to other sound sources that are not concerned, such as the sound of a neighboring speaker, the noise in the environment, etc. The shaded dots represent the short-time expression of the concerned target speaker, and the hollow dots represent the long-time expression of the target speaker. As shown in the schematic diagram of the speaker's expression when inputting the first frame of audio in FIG. 13, when the first frame of registration audio is input, in the first hidden state of the target speaker, the shaded dots representing the short-time expression and the hollow dots representing the long-time expression are distributed dispersedly. As shown in the schematic diagram of the speaker's expression after inputting the last frame of registration audio in FIG. 13, the first hidden state of the target speaker will become more and more accurate after multiple frame iterations, the shaded dots representing the short-time expression and the hollow dots representing the long-time expression gather together separately, and the two gathered dot sets are obviously separated from each other. The region where the short-time expression and the long-time expression are distributed can represent the target speaker. It can be clearly seen from FIG. 13 that the shaded dots and hollow dots representing the target speaker are far away from the interference expression, so the hidden state of the last frame can filter out the noise and other interference and accurately represent the features of the target speaker, and can effectively represent the implicit feature of the registration audio.

As shown in FIG. 5, the voice extraction network further includes a voice extraction module, and the first hidden state obtained by using the voice registration module may be used as the initial hidden state of the registration sound source (e.g., the target speaker). The core network in the voice extraction module is initialized by using the first hidden state, so that the hidden layer state of the core network of the hidden state analysis module is transferred to the voice extraction module to perform voice extraction by using the voice extraction module and the decoding module.

How to use the first hidden state to extract a target audio signal will be described below based on the operation 202.

At operation 202, the computer device extracts, based on the first hidden state corresponding to the voice registration module, a target audio signal from the second audio signal.

The computer device may extract a second audio feature of the second audio signal and then extract, based on the first hidden state and the second audio feature, a target audio signal from the second audio signal. Exemplarily, the target audio signal is an audio signal of the registration sound source. In the application, the target audio signal of the registration sound source in the second audio signal may be extracted by using the first hidden state of the registration sound source. For example, the voice of the target speaker is extracted from 10 s mixed audio by using the first hidden state obtained based on 0.5 s ultra-short-time voice of the target speaker.

In one possible example, the computer device may obtain, based on the first hidden state and the second audio feature, mask information corresponding to the target audio signal in the second audio signal, and extract the target audio signal from the second audio signal by using the mask information, wherein the mask information may represent the information proportion of the target audio signal in the second audio signal. Exemplarily, the implementation may include the following operations.

At a first operation, the computer device extracts a second audio feature of the second audio signal by using a second encoding module.

The second audio feature may represent a feature of the second audio signal in the frequency domain. In one possible example, the computer device may extract a frequency-domain feature of the second audio signal by using the second encoding module and then encodes the frequency-domain feature to obtain the second audio feature. In another possible example, the second audio feature may also represent a feature of the second audio signal in the frequency domain and a feature of the second audio signal in the time domain. For example, the computer device may extract a frequency-domain feature and a time-domain feature of the second audio signal respectively by using the second encoding module, and then encodes the frequency-domain feature and the time-domain feature to obtain the second audio feature.

In one possible implementation, it is possible to perform time-frequency transform process on the second audio signal to obtain the frequency-domain feature and then directly encode the frequency-domain feature to obtain the second audio feature. In another possible implementation, it is also possible to perform encoding on the frequency-domain feature of the second audio signal by sub-band, and the second audio feature may include the audio feature of each sub-band. Correspondingly, the implementation of the first operation may include the following two approaches.

Approach 1: the computer device may perform time-frequency transform process on the second audio signal by using the second encoding module to obtain the frequency-domain feature of the second audio signal; and, the computer device may also encode the frequency-domain feature to obtain the second audio feature.

Exemplarily, the frequency-domain feature may include the phase, amplitude or the like of the second audio signal in the frequency domain, and the computer device may further encode the phase, amplitude or other frequency-domain features into a higher-dimension second audio feature. The time-frequency transform process may include framing and windowing, and short-time Fourier transform. The implementations of the framing and windowing and the short-time Fourier transform are the same as those of the framing and windowing and the short-time Fourier transform described above and will not be repeated here.

For example, by taking the second audio signal having a duration of 8 s and 512 sampling points in each frame as an example, after short-time Fourier transform is performed on the second audio signal, the number of frames in the second audio signal is 499, and the number of frequency points in each frame is 256. Thus, the frequency-domain feature of this second audio signal may be expressed as a feature vector fₖ, where k represents the frame number, and k={0, 1, 2, . . . , 498}, and the dimension of the feature vector fₖ may be expressed as [499,256], that is, there are 499 frames and there are 256 frequency points in each frame. The feature vector may also be further encoded to obtain a higher-dimension feature vector. For example, the dimension of the encoded feature vector is [256,499,256], where the first 256 means the number of feature channels and the second 256 means that each frame has 256 frequency points.

If the second audio feature represents the features of the second audio signal in the frequency domain and the time domain, the computer device may also extract a time-domain feature of the second audio signal by using the second encoding module and then perform encoding based on the time-domain feature and the frequency-domain feature to obtain the second audio feature. For example, the encoded feature of the time-domain feature and the encoded feature of the frequency-domain feature of the second audio signal may be stitched to obtain the second audio feature.

Approach 2: the computer device performs time-frequency transform process on the second audio signal to obtain sub-band features corresponding to at least two preset frequency bands; and, the computer device extracts, by using a second encoding module respectively corresponding to each preset frequency band based on the sub-band features of the preset frequency band, a second audio feature corresponding to the preset frequency band.

The computer device may perform time-frequency transform process on the second audio signal to obtain a frequency-domain feature of the second audio signal, and perform sub-band division on the second audio signal based on the frequency-domain feature and at least two preset frequency bands to obtain sub-band features corresponding to the at least two preset frequency bands. The second audio feature may include the audio features of sub-bands of each preset frequency band. For each preset frequency band, the computer device may encode the sub-band features of the preset frequency band into a higher-dimension second audio feature by using the second encoding module corresponding to the preset frequency band. The computer device may split, based on at least two preset frequency bands, the frequency-domain feature of the second audio signal into frequency-domain features of sub-bands corresponding to the at least two preset frequency bands.

Exemplarily, by taking 4 sub-bands as an example, the frequency-domain feature of the second audio signal is divided into frequency-domain features corresponding to 4 sub-bands f1ₖ, f2ₖ, f3ₖ and f4ₖ according to the preconfigured 4 preset frequency bands (i.e., 0-2k, 2k-4k, 4k-8k and 8k-16k). The frequency points included in the sub-bands f1ₖ, f2ₖ, f3ₖ and f4ₖ are {1-32}, {33-64}, {65-128} and {129-256}, respectively.

For example, for the second audio signal having a duration of 8 s and 512 sampling points in each frame, the frequency-domain feature obtained by performing a time-frequency transform process on the second audio signal may be expressed as a feature vector having a dimension of [499,256]. Then, according to the 4 preset frequency bands, the feature vector having a dimension of [499,256] is divided into feature vectors corresponding to 4 sub-bands, and the frequency-domain features of sub-bands of each preset frequency band are encoded by using the sub-encoder corresponding to each preset frequency band. The sub-band encoders may perform encoding in parallel. The process of obtaining the corresponding higher-dimension feature vector will be described below.

For the feature vector x1ₖ of the second audio feature corresponding to the sub-band f1ₖ: the dimension of the frequency-domain feature vector of the sub-band f1ₖ is expanded from [499,64] to [1,1,499,64], a 2D convolution operation is performed on the expanded feature vector under an output channel of 256, a convolution kernel of 5*5 and a step of 1*1, and a feature vector x1ₖ corresponding to this sub-band f1ₖ is output, where the dimension of this feature vector is [1,256,499,64].

For the feature vector x2ₖ of the second audio feature corresponding to the sub-band f2ₖ: the dimension of the frequency-domain feature vector of the sub-band f2ₖ is expanded from [499,64] to [1,1,499,64], a 2D convolution operation is performed on the expanded feature vector under an output channel of 256, a convolution kernel of 5*5 and a step of 1*1, to obtain a feature vector x2ₖ, having a dimension of [1,256,499,64], of the audio feature of this sub-band f2ₖ, where the dimension of this feature vector is [1,256,499,64].

For the feature vector x3ₖ of the second audio feature corresponding to the sub-band f3ₖ: the dimension of the frequency-domain feature vector of the sub-band f3ₖ is expanded from [499,128] to [1,1,499,128], a 2D convolution operation is performed on the expanded feature vector under an output channel of 256, a convolution kernel of 5*6 and a step of 1*2, to obtain a feature vector x3ₖ having a dimension of [1,256,499,64].

For the feature vector x4ₖ of the second audio feature corresponding to the sub-band f4ₖ: the dimension of the frequency-domain feature vector of the sub-band f4ₖ is expanded from [499,256] to [1,1,499,256], a 2D convolution operation is performed on the expanded feature vector under an output channel of 256, a convolution kernel of 5*6 and a step of 1*4, to obtain a feature vector x4ₖ having a dimension of [1,256,499,64].

As shown in FIG. 5, the voice extraction network may include a second encoding module, and the second encoding module may have the same network structure as the first encoding module in the voice registration module. The implementation of extracting the second audio feature of the second audio signal by using the second encoder is described above, and will not be repeated here.

At a second operation, the computer device extracts, by using a voice extraction module based on the first hidden state and the second audio feature, mask information corresponding to the target audio signal from the second audio signal.

The computer device may initialize, by using the voice extraction module based on the first hidden state, a network hidden layer state of the voice extraction module to obtain a second hidden state of the voice extraction module; and, extract, based on the second audio feature and the second hidden state of the voice extraction module, mask information corresponding to the target audio information from the second audio signal. The second hidden state may represent an implicit feature of the registration sound source in the second audio signal. Exemplarily, the second hidden state may include, but not limited to: the short-time expression, long-time expression and context feature of the second audio signal.

It is to be noted that, in the application, the first hidden state can be quickly obtained by using the ultra-short-time first audio signal, and the network hidden layer state of the voice extraction module is initialized by using the first hidden state, so that the voice extraction module can obtain accurate mask information by using the initial implicit feature in combination with the second audio feature, so that the target audio signal can be quickly extracted by using the mask information subsequently, and the efficiency and practicability of audio signal processing are improved.

In one possible implementation, it is also possible to perform feature analysis on the second audio feature and then obtain mask information by using the second hidden state and the feature analysis vector. Exemplarily, the execution process of the second operation may include the following operation.

At a first operation, the computer device acquires, by using the voice extraction module and based on at least one feature analysis mode, at least one feature analysis vector of the second audio feature.

It is to be noted that the at least one feature analysis mode may include at least one of intra-frame analysis or inter-frame analysis, and the at least one feature analysis vector of the second audio feature may correspond to at least one of the intra-frame analysis vector or the inter-frame analysis vector. The way of acquiring at least one feature analysis vector of the second audio feature is the same process as the way of acquiring at least one feature analysis vector of the first audio feature as described above, and will not be repeated here.

Ata second operation, the computer device extracts, by using the voice extraction module based on the first hidden state and the at least one feature analysis vector of the second audio feature, mask information corresponding to the target audio signal from the second audio signal.

The voice extraction module may include an incremental update & speech extractor (IUSE) module; the IUSE module may include two core networks, i.e., a third core network and a fourth core network, respectively; and, one core network corresponds to one feature analysis vector. For each feature analysis vector, the computer device may extract, by using the core network corresponding to the at least one feature analysis vector based on the at least one feature analysis vector and the first hidden state corresponding to the at least one feature analysis vector, mask information corresponding to the target audio signal from the second audio signal.

The third core network is a network corresponding to the intra-frame analysis vector, and the fourth core network may be a network corresponding to the inter-frame analysis vector. Feature extraction may be performed by using the third core network based on the intra-frame analysis vector and the first hidden state corresponding to the intra-frame analysis vector; feature extraction is performed by using the fourth core network based on the inter-frame analysis vector and the first hidden state corresponding to the inter-frame analysis vector; and, mask information is further obtained by using the explicit feature obtained by feature extraction. The network structures of the third core network and the fourth core network may be the same as those of the first core network and the second core network, respectively. Therefore, the way of performing feature extraction on the two feature analysis vectors by using two core networks of the voice extraction module is the same as that for the two core networks of the hidden state analysis module, and will not be repeated here.

Exemplarily, the computer device may initiate the network hidden layer state of the third core network by using the first hidden state of the first core network during the feature extraction based on the intra-frame analysis vector, and initiate the network hidden layer state of the fourth core network by using the first hidden state of the second core network during the feature extraction based on the inter-frame analysis vector. Initializing the network hidden layer state of the core network means that the first hidden state is used as the initial value of the hidden state of the core network.

In one possible implementation, the computer device may also update the second hidden state of the voice extraction module during the feature extraction based on the second audio feature. On this basis, the operation may be replaced with the following step A.

At step A, the computer device extracts, by using the voice extraction module based on the first hidden state and the second audio feature, mask information corresponding to the target audio signal from the second audio signal, and update the second hidden state of the voice extraction module when extracting the mask information.

In one possible implementation, the computer device may obtain the mask information corresponding to each frame by a frame-by-frame iterative extraction method, and iteratively updates the second hidden state of the voice extraction module on a frame by frame basis when extracting the mask information corresponding to each frame. Exemplarily, the step A may include the following: for each frame in each block in the second audio signal, the computer device successively performs the following: the computer device extracts, by using the voice extraction module based on the second hidden state of the voice extraction module and the second audio feature of the current frame, mask information corresponding to the current frame from the second audio signal, acquires the second hidden state of the voice extraction module when extracting the mask information corresponding to the current frame, and updates, based on the acquired second hidden state, the second hidden state of the voice extraction module. Exemplarily, the mask information corresponding to the current frame may present the information proportion of the target audio signal in the current frame. For the first frame, the network hidden layer state of the voice extraction module may be initialized by using the first hidden state. For example, the computer device uses the first hidden state as the second hidden state of the voice extraction module, so as to subsequently extract the mask information corresponding to the first frame by using the second hidden state and the second audio feature of the first frame.

Exemplarily, the voice extraction module includes at least one of the following: a recurrent neural network, an attention network, a transformer network and a convolutional network. For example, the core network of the voice extraction module may be an LSTM network.

In one possible implementation, it is possible to extract mask information on a frame by frame basis based on the sequential order of each frame in the second audio signal and then update the first hidden state. Correspondingly, the process of the step A may include: for each frame in the second audio signal, successively performing the following in the sequential order of frames: extracting, by using the voice extraction module based on the second hidden state corresponding to a frame preceding the current frame and the second audio feature of the current frame, mask information corresponding to the current frame from the second audio signal; acquiring a second hidden state of the voice extraction module when extracting the mask information corresponding to the current frame; and updating, based on the acquired second hidden state, the second hidden state of the voice extraction module.

When each frame is successively processed in the sequential order, for the first frame, the network hidden layer state of the voice extraction module may be initialized by using the first sequential hidden state. For example, the computer device uses the first sequential hidden state as the second hidden state of the voice extraction module.

In another possible implementation, it is possible to perform feature extraction based on an inverse order of frames and then update the first hidden state. Correspondingly, the process of the step A may include: for each frame in the second audio signal, successively performing the following based on an inverse order of frames: extracting, by using the voice extraction module based on the second hidden state corresponding to a frame subsequent to the current frame and the second audio feature of the current frame, mask information corresponding to the current frame from the second audio signal; acquiring a second hidden state of the voice extraction module when extracting the mask information corresponding to the current frame; and updating, based on the acquired second hidden state, the second hidden state of the voice extraction module.

When each frame is processed in the inverse order, for the last frame, the network hidden layer state of the voice extraction module may be initialized by using the first reverse hidden state. For example, the computer device uses the first reverse hidden state as the second hidden state of the voice extraction module.

In another possible implementation, the implementations corresponding to the sequential order and the inverse order may be combined. For example, the sequential voice extraction module is initialized by using the first sequential hidden state, and the sequential mask information of each frame is successively extracted in the sequential order (for example, the mask information extracted in the sequential order is called sequential mask information). Then, the reverse voice extraction module is initialized by using the first reverse hidden state, and the reverse mask information of each frame is successively extracted in the inverse order (e.g., the mask information extracted in the inverse order is called reverse mask information). For each frame, the mask information of this frame may be determined by combining the sequential mask information and the reverse mask information corresponding to this frame. For example, the average of the sequential mask information and the reverse mask information is used as the mask information of this frame.

In one possible example, the implementation of updating the second hidden state of the voice extraction module based on the acquired second hidden state may include the following operation A1.

At operation A1, the computer device updates the acquired second hidden state as the second hidden state of the voice extraction module.

The second hidden state corresponding to the current frame is used as the latest second hidden state of the voice extraction module. For a next frame of the current frame, the mask information corresponding to the next frame is extracted from the second audio signal by using the second hidden state corresponding to the current frame and the second audio feature of the next frame.

Exemplarily, if the second audio signal includes M frames (where M is a positive integer and 0<i<M), for the first frame in the M frames, the second hidden state of the voice extraction module is acquired based on the first hidden state, and the mask information is extracted by using the second hidden state; then, the second hidden state of the voice extraction module when extracting the mask information corresponding to the first frame (i.e., the second hidden state corresponding to the first frame) is acquired; and, the second hidden state of the voice extraction module is updated based on the acquired second hidden state. For the (i+1)^{th} frame in the M frames, the mask information corresponding to the (i+1)^{th} frame is extracted from the second audio signal by using the second hidden state corresponding to the i^{th} frame and the second audio feature of the (i+1)^{th} frame; then, the second hidden state of the voice extraction module when extracting the mask information corresponding to the (i+1)^{th} frame (i.e., the second hidden state corresponding to the (i+1)^{th} frame) is acquired; and, the second hidden state of the voice extraction module is updated based on the acquired second hidden state. Such a cycle is repeated until the mask information corresponding to the M^{th} frame is obtained, and the second hidden state corresponding to the M^{th} frame is acquired to update the second hidden state of the voice extraction module.

It is to be noted that, when the approach at the operation A1 is adopted, the first hidden state is used as the initial hidden state, and the mask information is extracted by using the second hidden state corresponding to the previous frame and the second audio feature of the current frame, so that the hidden state corresponding to the previous frame is used when extracting the mask information corresponding to each frame, and the initial hidden states of frames can be updated on a frame by frame basis.

In another possible example, the implementation of updating the second hidden state of the voice extraction module based on the acquired second hidden state may include the following operation A2.

At operation A2, the computer device updates the second hidden state of the voice extraction module based on the acquired second hidden state and the second hidden state corresponding to the preset frame.

Exemplarily, the preset frame may be a preconfigured frame, for example, previous frame, two previous frames preceding the current frame or more frames preceding the current frame, etc. The preset frame may be configured as required, and will not be limited in the application. The computer device may perform averaging, summation, feature stitching or other processing on the acquired second hidden state and the second hidden state corresponding to the preset frame, and then update the processed second hidden state as the second hidden state of the voice extraction module.

In another possible implementation, the second hidden state of the voice extraction module may also be updated in blocks. The second audio signal includes at least one block, and each block includes at least one frame. The computer device may update the second hidden state of the voice extraction module when processing each block in a block-by-block iterative updating manner. Exemplarily, the step of updating, by the computer device, the second hidden state of the voice extraction module may include the following operations B1 to B2.

At operation B1, the computer device predicts, based on the first hidden state corresponding to the voice registration module and a historical second hidden state of the voice extraction module, the second hidden state of the voice extraction module when processing the current block.

In one possible example, the historical second hidden state of the voice extraction module includes: the second hidden state of the voice extraction module when the voice extraction module processes a preset frame of a preset block preceding the current block. The preset block may be one previous block, two previous blocks or more blocks preceding the current block, etc. The preset frame may be the last one frame, last two frames or more last frames of each preset block, etc.

In one possible example, the current block may be predicted by an attention mechanism. The computer device may predict, by using a window attention module based on the first hidden state corresponding to the voice registration module and the historical second state of the voice extraction module, the historical second hidden state of the voice extraction module when processing the current block.

At operation B2, the computer device updates the second hidden state of the voice extraction module based on the predicted second hidden state.

The computer device may update the predicted second hidden state as the second hidden state used by the voice extraction module when processing the first frame of the current block. The predicted second hidden state is used to initialize the hidden layer state of the voice extraction module when the voice extraction module is used to process the first frame of the current block. For example, the computer device updates the predicted second hidden state as the second hidden state of the voice extraction module, and then extracts the mask information corresponding to the first frame by using the voice extraction module based on the second hidden state and the second audio feature of the first frame, so as to obtain the mask information corresponding to each frame in the current block in a frame-by-frame iterative extraction manner. The implementation of extracting the mask information corresponding to each frame in each block in a frame-by-frame iterative extraction manner is the same as the process of extracting the mask information corresponding to the current frame in a frame-by-frame iterative extraction manner at the step A, and will not be repeated here.

By combining the first hidden state and the historical second hidden state, the second hidden state used when processing the current block is predicted. For example, the second hidden state used when extracting the mask information corresponding to the first frame of the current block is predicted by using the first hidden state and the second hidden state corresponding to the last frame of the previous block. Thus, the first hidden state is iteratively updated for each of the blocks on a block by block basis, and it is ensured that the second hidden state of the voice extraction module when processing each block is accurately updated with respect to the first hidden state of the registration sound source. For example, the second audio signal may have a duration of 8 s, and each block may have a duration of 2 s.

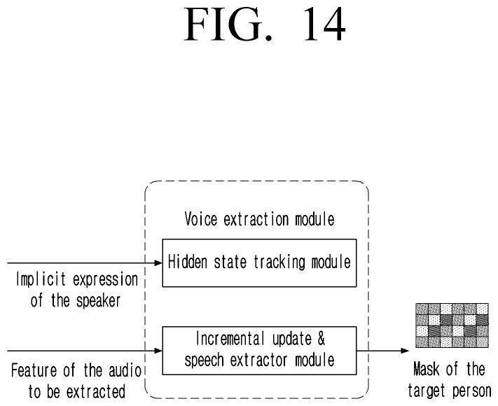

FIG. 14 is a schematic structure diagram of a voice extraction module according to an embodiment of the disclosure. The computer device may acquire the mask of the registration sound source by using the voice extraction module.

Referring to FIG. 14, the voice extraction module includes a hidden state tracking module, and an incremental update & speech extractor (IUSE) module. The network hidden layer state of the IUSE module is initialized by using the first hidden state s i_{org} obtained by the voice registration module; and, mask information is extracted by using the second audio feature of the second audio signal to be extracted, and the first hidden state of the registration sound source is updated. The second hidden state corresponding to each block may be predicted based on the first hidden state and the historical second hidden state by using the hidden state tracking module, thereby ensuring the updating of the hidden state. The mask information may be the mask of the registration sound source in the second audio signal output by the voice extraction module, and the mask may represent the information proportion of the target speaker in the corresponding feature space.

It is to be noted that the speaker expression extracted in the prior art will not be updated during voice extraction. The IUSE module in the application is implemented by a network with the timing processing capability (e.g., LSTM, CNN), so that the IUSE module can update the hidden state of the voice extraction module on a frame by frame basis. At the beginning of extracting the mask information, the first hidden state inferred by the voice registration module can be used as the initial hidden state siₒᵣg to initiate the network hidden layer state of the IUSE module. For the processing of each frame, the mask information corresponding to each frame is extracted by the IUSE module, and the hidden layer state thereof is updated for use in the next frame. On this basis, when the hidden state is transferred on a frame by frame basis, the first hidden state and the second hidden state as the initial hidden state will also be updated on a frame by frame basis, so that the short-time expression is more and more accurate.

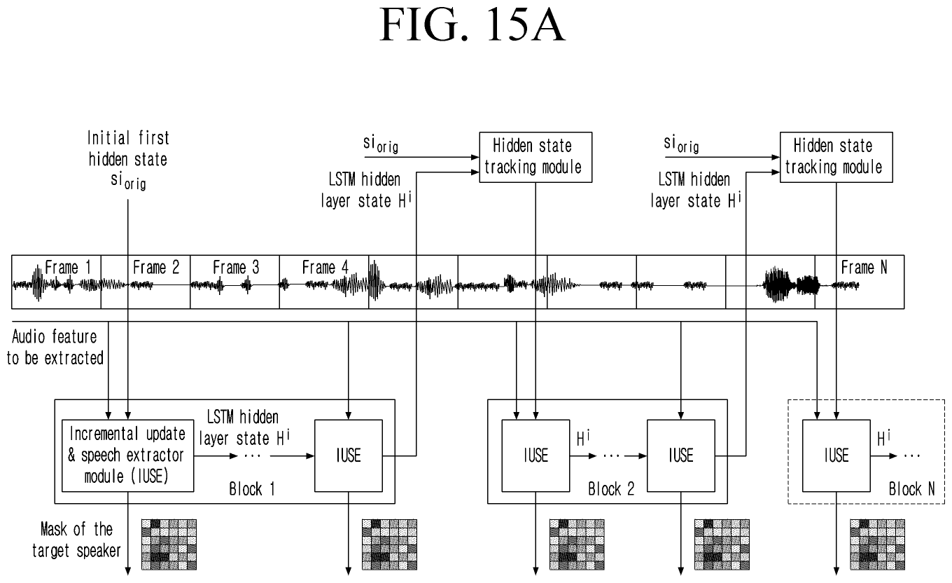

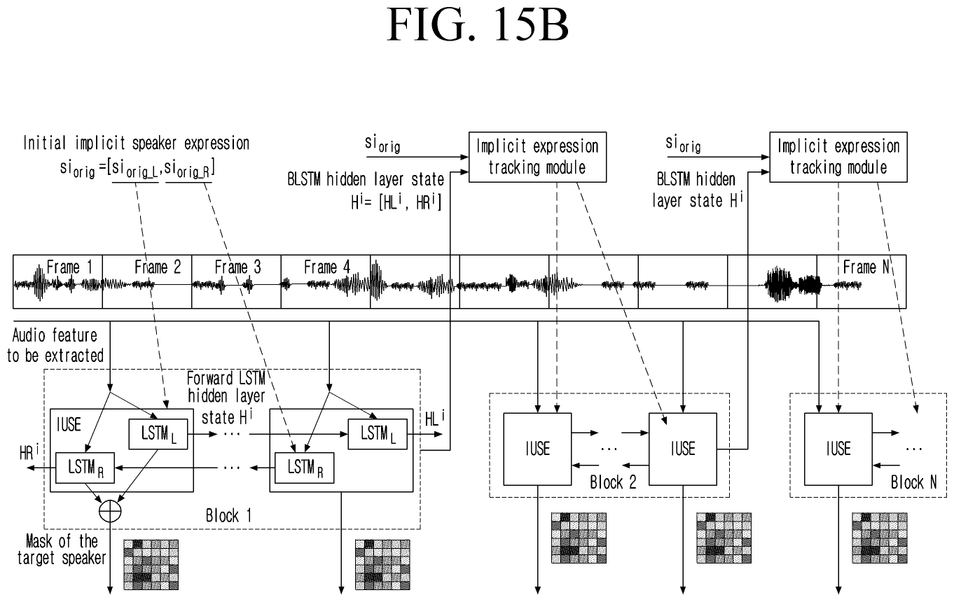

FIG. 15A is a timing flowchart of a voice extraction module according to an embodiment of the disclosure.

Referring to FIG. 15A, the second audio signal to be extracted may include a plurality of frames, so there are second audio features corresponding to a plurality of frames. It is also possible to divide the plurality of frames into a plurality of blocks Block1, Block2, . . . , BlockN. For a plurality of frames included in each block, the mask information of the target speaker may be extracted by using the IUSE module in a frame-by-frame iteration manner, and the second hidden state of the IUSE module is updated in a frame-by-frame iteration manner. For each block, the second hidden state corresponding to the current block is predicted by using the hidden state tracking module in combination with the first hidden state and the second hidden state corresponding to the last frame of the previous block. Finally, the mask information corresponding to each frame in each sub-band is obtained. For example, for each block, the second audio feature of each frame included in this block is input into the IUSE module, and the second audio feature of the current frame may be modeled by using the IUSE module based on the second hidden state corresponding to the previous frame to obtain the mask information of the current frame. In this frame-by-frame iteration manner, the mask information of the last frame is obtained when the last frame is modeled.

FIG. 15B is a timing flowchart of a voice extraction module according to an embodiment of the disclosure.

Referring to FIG. 15B, if the first hidden state includes a first sequential hidden state and a first reverse hidden state, the process of acquiring mask information will be described by taking the process shown in FIG. 15B as an example. Referring to FIG. 15B, the implicit expression tracking module is the hidden state tracking module, and the initial implicit speaker expression is the initial first hidden state. The voice extraction module may also be implemented by using a BLSTM network correspondingly, that is, the structure of core network of the voice extraction module also uses the same BLSTM structure as the hidden state analysis module. In other words, in the voice extraction module, in the first frame of one block, the network hidden state of the forward LSTM_{L} for voice extraction is initialized by using the si_{orig}_{_{L}} of the hidden state analysis module to extract the sequential mask information corresponding to the first frame based on the first sequential hidden state and the second audio feature of the first frame of the second audio signal, and the network hidden state of the forward LSTM_{L} is updated based on the acquired first sequential hidden state corresponding to the first frame to extract the sequential mask information corresponding to each frame on a frame by frame basis. In the last frame, the network hidden state of the backward LSTM_{R} of the voice extraction module is initialized by using the si_{orig_R} of the hidden state analysis module to extract the reverse mask information corresponding to the last frame based on the second audio feature of the last frame and the first reverse hidden state, and the network hidden state of the backward LSTM_{R} is updated based on the acquired first reverse hidden state corresponding to the last frame to extract the reverse mask information corresponding to each frame on a frame by frame basis. For each frame, the average of the sequential mask information and the reverse mask information corresponding to this frame may be used as the mask information corresponding to this frame.

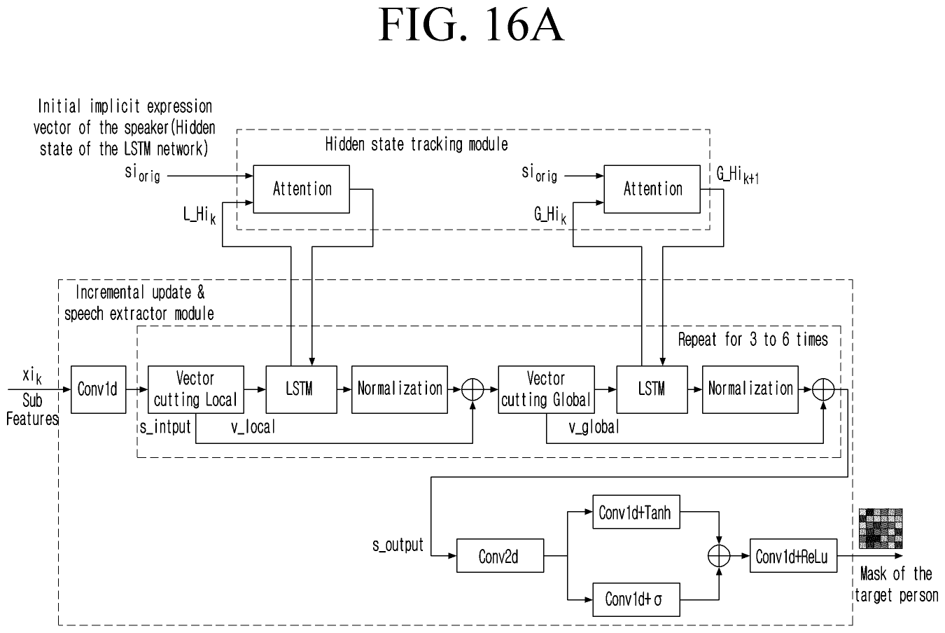

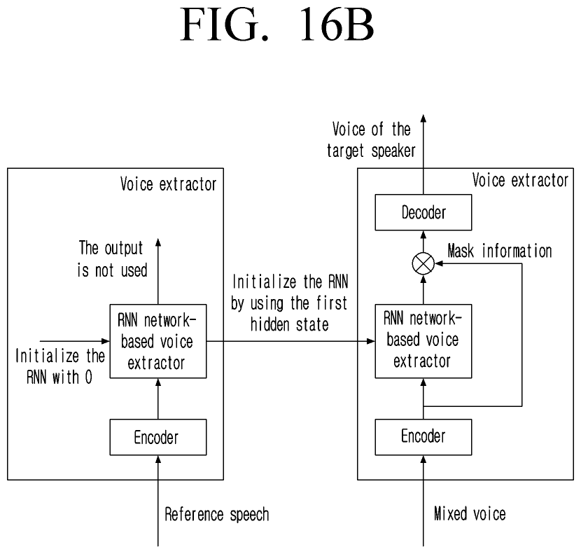

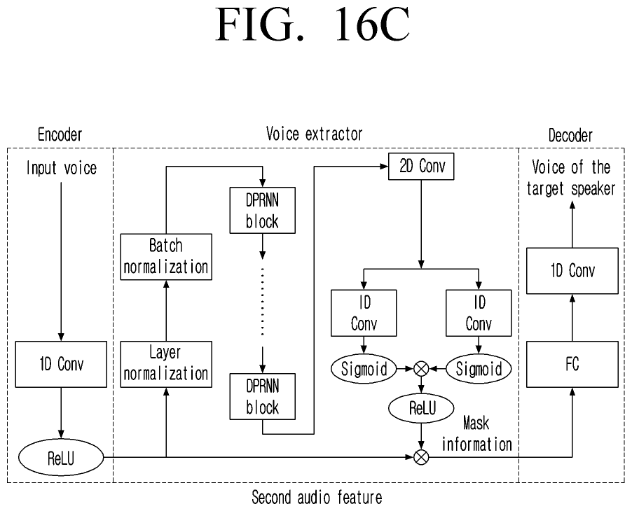

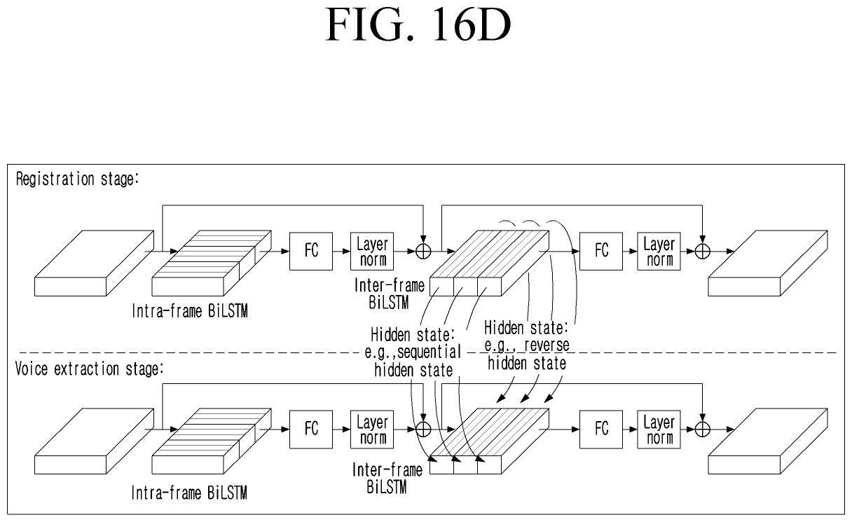

Of course, if the hidden state analysis module only uses the network hidden state of the second LSTM network (i.e., the LSTM network that processes the vector v_global in the network structure diagram shown in FIG. 12) as the first hidden state, that is, si_{orig}=[si_{orig_global_R}], in the voice extraction module, only the hidden state of the second LSTM network (e.g., the LSTM network that processes the vector v_global in the network structure diagram shown in FIG. 16A) in the voice extraction module is initialized. Similarly, for the implementation of the hidden state analysis module using the BLSTM, if only the hidden state of the second BLSTM network is used as the output si_{orig}=[si_{orig_global_L},si_{orig_global_R}] of this module, the network hidden states of the forward LSTM and the backward LSTM of the second BLSTM network in the voice extraction module are initialized by using si_{orig_global_L} and si_{orig_global_R}, respectively.

In the application, the core network of the IUSE module may also use an LSTM network, which has the same structure as the LSTM network of the hidden state analysis module. The hidden state si_{orig} learnt by the hidden state analysis module may be used to initialize the network hidden layer state of the core network LSTM of the IUSE module. As shown in the timing diagram of FIG. 15A, in each Block with a duration of 2 s, the IUSE module continuously updates the hidden layer state Hⁱ of the LSTM network by processing the data of each frame, and the hidden layer state Hⁱ contains the registration sound source, for example, the short-time expression, long-time expression, context feature or other information of the target speaker, where i represents the i^{th} sub-band.

FIG. 16A is a schematic diagram of a network structure of a voice extraction module according to an embodiment of the disclosure. FIG. 16A provides a network structure diagram of an IUSE module. The detailed processing flow of the IUSE module includes the following four steps (the operations 1, 2 and 3 may refer to the hidden state analysis module).

At operation 1, dimension reduction is performed on the feature vector of the second audio feature of the input second audio signal.

For example, the feature dimension of the feature vector is reduced from 256 to 64 by a 1D convolution operation.

At operation 2, the feature vector is analyzed in at least one feature analysis mode to obtain a corresponding feature analysis vector.

For example, intra-frame analysis is performed by transverse local cutting to obtain an intra-frame analysis vector. It is also possible to perform inter-frame analysis by longitudinal global cutting to obtain an inter-frame analysis vector.

At operation 3, at least one feature analysis vector is modeled by using at least one core network.

For example, the first hidden state corresponding to the first core network in the hidden state analysis module is used to initialize the corresponding third core network in the IUSE. Similarly, the first hidden state corresponding to the second core network in the hidden state analysis module may be used to initialize the corresponding fourth core network in the IUSE. For the operation 1 to 3, since the third core network and the fourth core network in the IUSE module has the same network structure as the hidden state analysis module, the steps 1 to 3 may be implemented by the same process described above. Different from the hidden state analysis module, the IUSE module further includes a hidden state tracking module. The second hidden state corresponding to each block is predicted by using the hidden state tracking module based on the first hidden state and the second hidden state of the previous block.

At operation 4, the mask is calculated.

Referring to FIG. 16A, the output feature analysis vector s_output passes through a convolutional layer and a Tanh activation layer respectively to obtain a first output vector, and the feature analysis vector s_output passes through a convolutional layer and a sigmoid activation layer to obtain a second output vector. The two output vectors are multiplied to obtain a feature vector. The dimension of the feature vector obtained after multiplication may be [m,64, 499,64]. The m represents the number of registration sound sources, 64 represents 64 feature channels, and each of 499 frames includes 64 frequency points. Finally, through the dimension recovery by a convolutional layer and a ReLU activation layer, the dimension of the mask information miₖ finally output by the voice extraction module is [m,256,499,64]. In [m,256,499,64], m represents the number of sound sources to be extracted, 256 represents the number of feature channels (that is, there are 256 feature dimensions), 499 represents the number of frames, 64 represents the number of frequency components of this sub-band, and miₖ represents the mask value of each frequency point of each of the 499 frames at each feature dimension. For example, in the application, the m may have a value of 2, representing the target speaker to be extracted and another sound source.

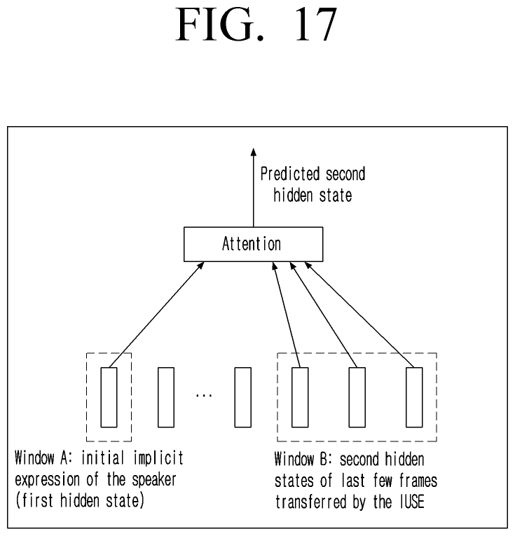

FIG. 17 is a timing flowchart of a voice extraction module according to an embodiment of the disclosure.

Referring to FIG. 17, in the disclosure, a dual-window mechanism may be employed in the window attention module. The window attention module includes a first attention window and a second attention window, wherein the first attention window is configured to continuously concern the first hidden state when processing each block, and the second attention window is configured to concern the historical second hidden state of the preset frame including the preset block so as to introduce the first hidden state to predict the second hidden state corresponding to each block. Referring to FIG. 17, the conventional attention network only includes the information output by few blocks in the window B shown in FIG. 17, so there is a problem that the initial hidden state is forgotten. However, in the application, to update the hidden state with respect to the registration sound source correctly, the reference to the initial first hidden state may be introduced during updating. In the application, by adding another window, e.g., the window A shown in FIG. 17, the window A continuously concerns the first hidden state of the registration sound source (i.e., the initial hidden state of the target speaker) during the updating of the hidden state of each Block, so that the initial hidden state of the target speaker can be continuously concerned and the updating is more stable and controllable.

The hidden state tracking module is configured to update the hidden state on a block by block basis. The input of the hidden state tracking module is the historical second hidden state, for example, the second hidden state corresponding to the previous block, and the output of the hidden state tracking module is the predicted second hidden state corresponding to the current block, and the predicted second hidden state is used to initialize the network hidden layer state of the core network of the IUSE module when processing the current block. The hidden state tracking module may be implemented by an attention network. Of course, the specific implementation may also be replaced with other networks with the ability to analyze long-time features. As shown in the timing diagram of FIG. 15A, during processing each Block, both the initial hidden state si_{orig} and the hidden layer state Hⁱ of the LSTM network when processing the previous block will be input into the attention network, so that the network will continuously update Hⁱ according to the newly input audio data in the process of keep tracking si_{orig}, and initialize the hidden layer parameter of the LSTM network by using the updated Hⁱ during processing the next Block. As shown in FIG. 15A, after the LSTM processing the v_local vector processes each Block, the network will output its hidden layer state parameter L_Hiₖ to the attention network layer, and the attention network layer will jointly model si_{orig} and L_Hiₖ and output new L_Hiₖ to initialize this LSTM network, so that the next Block is processed by using the initialized LSTM network.

For the IUSE module, the second audio signal may be processed by using the IUSE module to obtain accurate long-time expression. However, when the network nodes are limited, if the data duration is too long to fully remember the state information of all frames, it is easy to lose some historical information. To solve this problem, the applicant has proposed a block-by-block updating method and also a dual-window attention mechanism based on the window attention module to update the second hidden state of the LSTM when processing each block, so as to extract more accurate long-time expression. Generally, one sentence with a duration of 4 s to 7 s may contain rich information to express the short-time expression and long-time expression of the speaker. For example, in the application, the duration of the block may be set to 2 s to reduce the computation complexity. After one block is processed by the IUSE module, the second hidden state when this block is processed by the IUSE (i.e., the second hidden state when the modeling of the last frame in this block is completed) may be output. The second hidden state corresponding to this block is output to the hidden state tracking module. The second hidden state used when processing the next block may be predicted by using the hidden state tracking module based on the first hidden state and the second hidden state of this block and then output to the IUSE module that processes the first frame in the next block, so as to update the network hidden layer state of the IUSE module when processing the next block.

In the application, there is provided a VE-VE (voice extractor-voice extractor) network framework for implementing voice extraction tasks for a target source (e.g., a target speaker), and registration is performed with ultra-short-time voice to realize voice extraction. The same voice extraction step may be used in the registration stage and the extraction stage using the hidden state in the registration stage. The effects achieved by the application include, but not limited to, the following (1)-(3).

(1) The application designs a novel network formwork for extracting a target speaker's voice. In the application, feature extraction may be performed by using a recurrent neural network (RNN) to realize voice extraction. The voice extractors in the registration stage and the extraction may have the same network structures and weights. The RNN state carries speaker information, which may be called an implicit speaker expression (ISE) in the application and may be used to replace steaming speaker embedded features. In the voice extraction stage, the ISE obtained in the registration stage may be used as the initialized state of the voice extractor in the voice extraction stage.

(2) The application proposes to verify the effectiveness of the voice extraction framework provided by the application by using the VE-VE network. Experiments show that the method of the application realizes new advanced performances (SOTA) on the common WSJ0-2mix dataset.

(3) The method of the application can support ultra-short-time registration voice, for example, 0.5 s voice.

In the application, voice registration is performed by using the voice extractor. The voice extractor in the registration stage and the voice extractor in the extraction stage have the same structure, so the features of the voice extractors in the registration stage and the extraction stage are located in the same feature space. In the related technologies, it is necessary to fuse embedded features and mixed voice features; however, in the application, it is easier to realize feature fusion based on the voice extractors in the same feature space.

In the application, the voice extractor based on the RNN network may be used. The RNN network may have the memory capability, so that the current moment may be instructed by using the historical state of the voice at the previous moment. Apparently, the state information of the RNN network may be stored with the implicit features of the target speaker, thereby instructing the network to perform voice extraction. Therefore, the characteristics of the speaker in the registration stage may be represented based on the RNN hidden state. Since the characteristics of the speaker are hidden in the RNN state and the state further contains other information, it may be also called an implicit speaker expression (ISE) in the application.

One advantage of using the ISE as the speaker feature lies in that: it is unnecessary for the RNN network to fuse the voice feature with the ISE. During voice extraction, the ISE may be used as the initialized hidden state of the RNN network when performing voice extraction. Another advantage is that it may support ultra-short-time voice registration. As the network operates, the RNN state is continuously updated, so the ISE may also be continuously updated in the voice extraction step after the voice registration. On this basis, in the registration stage, only one piece of ultra-short-time voice (e.g., 0.5 s voice) is needed for the extraction of the ISE.

FIG. 16B is schematic diagram of a network structure based on a VE-VE network framework according to an embodiment of the disclosure.

Referring to FIG. 16B, based on the above factors, the application designs a VE-VE framework for implementing speaker extraction tasks. The VE-VE framework is as shown in FIG. 16B, and the hidden state analysis module and the voice extraction module may be two RNN network-based voice extractors, i.e., VE-VE network frameworks. The two RNN network-based voice extractors have the same network structures and attributes (for example, the network structures and weights may be the same). In the registration stage, there is no need for the decoder of the voice extractor or the explicit feature output by the voice extractor, and only the ISE is reserved as the speaker's feature. The RNN in the registration stage uses 0 as the initial state, while the RNN in the extraction stage uses the ISE as the initial state. The RNN network in the voice registration stage and the RNN network in the extraction stage may have the same network structures and weights. Referring to FIG. 16B, the reference speech may be used as registration voice, i.e., the first audio signal. In the registration stage, the voice extractor (i.e., the hidden state analysis module) of the RNN is initialized with 0, and feature extraction is performed on the first audio signal by using the initialized hidden state analysis module, wherein the voice extractor of the RNN in the extraction stage is initialized by using the ISE obtained in the registration stage, rather than using the explicit feature output by the hidden state analysis module during feature extraction. In the extraction stage, with the initialized RNN network, the feature extraction is performed on the mixed audio feature obtained by encoding the mixed voice to obtain mask information of the mixed voice, and the target speaker's voice is extracted from the mixed voice by using the mask information and the mixed audio feature.

In the application, the VE-VE network framework used for voice extraction tasks may be implemented by a dual-path-RNN (DPRNN). For example, in the voice extraction module, the input mixed voice is divided into short blocks by using the DPRNN, so that the long sequence modeling problem is solved and better effects are achieved.

FIG. 16C is a schematic diagram of a network structure based on a VE-VE network framework according to an embodiment of the disclosure.

Referring to FIG. 16C, the network structure of the voice extractor is as shown in FIG. 16C, and the DPRNN voice extractor may include L stacked DPRNN blocks. Each DPRNN block contains 2 BiLSTM layers, including intra-frame BiLSTM (Local BiLSTM) and inter-frame BiLSTM (Global BiLSTM). During the intra-frame analysis, the Local BiLSTM is used to extract an intra-frame (intra-chunk) feature; and, during the inter-frame analysis, the Global BiLSTM is used to extract an inter-frame (inter-chunk) feature. Firstly, the mixed voice is encoded by using the encoder, and the encoded feature is subjected to layer normalization, batch normalization (BN) or other processing and then input to the DPRNN voice extractor. The intra-frame analysis feature is input into the Local BiLSTM, and the inter-frame analysis feature is input into the Global BiLSTM. In the DPRNN, processing is performed by each stacked DPRNN block, and convolution and activation function processing (e.g., the Tanh activation function, the Sigmoid activation function, the ReLu activation function, etc. shown in FIG. 16A) are performed to predict the mask information corresponding to each frame in the mixed voice. The audio feature of the target speaker is extracted from the audio feature of the mixed voice based on the mask information and the audio feature of the mixed voice. In the decoder, the extracted feature is subjected to convolution through the fully connected (FC) layer to reconstruct the target speaker's voice, so that the target speaker's voice is extracted from the mixed voice.

In the registration stage, the initialized states of both the intra-frame BiLSTM and the inter-frame BiLSTM are 0. For example, the hidden state of the intra-frame BiLSTM and the hidden state of the inter-frame BiLSTM are used as the implicit speaker expression. In another example, considering that the speaker feature including a long-time global feature, it is also possible use only the hidden state of the inter-frame BiLSTM as the implicit speaker expression, and there is no need to use other outputs (e.g., explicit features and the state of the intra-frame BiLSTM) of the intra-frame BiLSTM and the inter-frame BiLSTM.

In the registration stage, by taking using only the hidden state of the inter-frame BiLSTM as an example, the process of processing the input registration voice is as follows:

Seqₒᵤₜ^{N×2K},(h_{N},c_{N})=BiLSTM_{Global}^{l}N(Seqᵢₙ^{N×K},(h₀,c₀));

where l represents the DPRNN block number, for example, the l^{th} DPRNN block among the L stacked DPRNN blocks, and BiLSTM_{Global}^{l} is the inter-frame BiLSTM in the l^{th} DPRNN block. N represents the sequence length of the encoded registration voice, for example, which may represent the duration in the time domain and may represent the number of frames in the frequency domain. K represents the feature dimension of the input inter-frame analysis feature. Seqᵢₙ^{N×K} and Seqₒᵤₜ^{N×2K} represent the feature of the registration voice input into the inter-frame BiLSTM and the feature of the registration voice output by the inter-frame BiLSTM, respectively. (h₀,c₀) represents the initial hidden state of the inter-frame BiLSTM, where h₀ represents the initial hidden state, c₀ represents the initial cell state, and (h₀,c₀) may be initialized with 0 in the registration stage. The hidden state mainly stores the short-term memory of the network and thus may represent the short-time feature of the target speaker. The cell state mainly stores the long-term memory of the network and thus may represent the long-time feature of the target speaker. Due to the presence of the cell state, the network can have the ability to effectively depict information with a large time span. (h_{N},c_{N}) represents the implicit speaker expression, i.e., the final hidden state of the inter-frame BiLSTM at the end of feature extraction.

In the extraction stage, if only the hidden state of the inter-frame BiLSTM is used as the implicit speaker expression, the initialized state of the intra-frame BiLSTM is 0. The hidden state of the inter-frame BiLSTM is initialized by using the implicit speaker expression of the registration stage, the inter-frame BiLSTM can inherit the implicit speaker expression in the registration voice. In the extraction stage, by taking using only the hidden state of the inter-frame BiLSTM as an example, the process of processing the input mixed voice is as follows:

Seqₒᵤₜ^{M×2K},(h_{M},c_{M})=BiLSTM_{Global}^{l}(Seqᵢₙ^{M×K}(h_{N},c_{N}));

where M represents the sequence length of the encoded mixed voice, for example, which may represent the duration in the time domain and may represent the number of frames in the frequency domain; (h_{M},c_{M}) represents the final hidden state of the inter-frame BiLSTM in the extraction stage at the end of feature extraction; and, Seqᵢₙ^{M×K} and Seqₒᵤₜ^{M×2K} represent the feature of the mixed voice input into the inter-frame BiLSTM and the feature of the mixed voice output by the inter-frame BiLSTM, respectively.

It is to be noted that, if the registration stage includes L DPRNN blocks, the extraction node has L DPRNN blocks correspondingly. In the registration stage, each DPRNN block may be processed by the intra-frame BiLSTM and the inter-BiLSTM in this DPRNN block. On this basis, in the registration stage, the processing is successively performed by the L DPRNN blocks, and the initial hidden state of each DPRNN is initialized with 0 to obtain the hidden states respectively corresponding to the L DPRNN blocks. Therefore, in the extraction stage, the hidden states of the corresponding DPRRN blocks in the extraction stages may be initialized by using the corresponding DPRNN blocks in the registration stage, respectively. For example, the hidden stage of the first DPRNN block in the extraction stage is initialized by using the first hidden state of the first DPRNN block in the registration stage.

FIG. 16D is a schematic diagram of a corresponding structure of a DPRNN Block of a VE-VE network framework according to an embodiment of the disclosure.

Referring to FIG. 16D, in the registration stage, the first audio feature of the registration voice is subjected to feature extraction through the intra-frame BiLSTM network, then subjected to layer normalization through the fully connected layer, and subjected to inter-frame feature analysis. The obtained inter-frame feature is input into the inter-frame BiLSTM network for feature extraction, and then subjected to layer normalization through the filly connected layer to eventually obtain the first hidden state. The first hidden state may include a first sequential hidden state and a first reverse hidden state. In the registration stage, the initialized states of both the intra-frame BiLSTM and the inter-frame BiLSTM are 0. In one example, the last state of the inter-frame BiLSTM (i.e., the first sequential hidden state corresponding to the last frame and the first reverse hidden state corresponding to the first frame) may be used as the implicit speaker expression, so that the long-term feature of the speaker is better extracted based on the feature extraction process of the inter-frame feature. Other explicit features or the hidden state of the intra-frame BiLSTM may not be used. Correspondingly, in the voice extraction stage, the initialized stage of the intra-frame BiLSTM is 0, and the inter-frame BiLSTM is initialized by using the implicit speaker expression obtained in the registration stage, so that the inter-frame BiLSTM can inherit the implicit expression information of the registered user.

In the voice registration module, the accuracy of the short-time acoustic expression extracted from 0.5 s registration voice is improved by frame-by-frame iteration, alternate modeling using at least one feature analysis, etc. Further, in the application, by updating the hidden state of the registration sound source on a block by block basis, the accuracy of the long-time expression extracted from 0.5 s registration voice is improved. Based on the following two reasons, the hidden state can be updated in the voice extraction stage to improve the accuracy of the short-time expression and the long-time expression and thus improve the performance of audio signal processing.

Firstly, when the second audio signal is processed in the voice extraction stage, a large amount of new voice data will be input. The initial hidden state can be updated by using the information of the target speaker in the new voice data, so that the initial hidden state si_{orig} obtained by using 0.5 s registration voice can be updated more accurately, and the purpose of accurately extracting the voice of the target speaker can be achieved by ultra-short-time registration.

Secondly, the initial hidden state can be updated by using the core network (i.e., the IUSE module) in the voice extraction module, and the structure of the core network of the hidden state analysis module in the voice registration module is the same as the network structure of the core network in the voice extraction module. That is, two LSTMs in the hidden state analysis module have the same network structure as the two LSTMs in the voice extraction module. Therefore, the hidden layer state of the core network in the voice extraction module can also be used as the hidden state of the registration sound source. Meanwhile, the hidden layer state of the core network (i.e., the IUSE module) in the voice extraction module is updated on a block by block basis and on a frame by frame basis in the voice extraction stage, so that the hidden state can be updated.

According to an embodiment of the disclosure, the computer device determines, by using a decoding module based on the second audio feature of the second audio signal and the mask information, the target audio signal.

In one possible implementation, the computer device may decode, by using the decoding module based on the mask information and the second audio feature, the target audio signal from the second audio signal.

In one possible example, if the second audio feature includes sub-band features of at least two preset frequency bands of the second audio signal and the mask information includes the mask information of each preset frequency band, the computer device may extract the predicted feature of each preset frequency band and integrally extract the target audio signal of the full band based on the predicted feature of each preset frequency band. This operation may include the following: the computer device determines the predicted feature of each preset frequency band by using the decoding module respectively corresponding to each preset frequency band based on the sub-band features of each preset frequency band and the mask information, and determines the target audio signal based on the predicted feature of each preset frequency band.

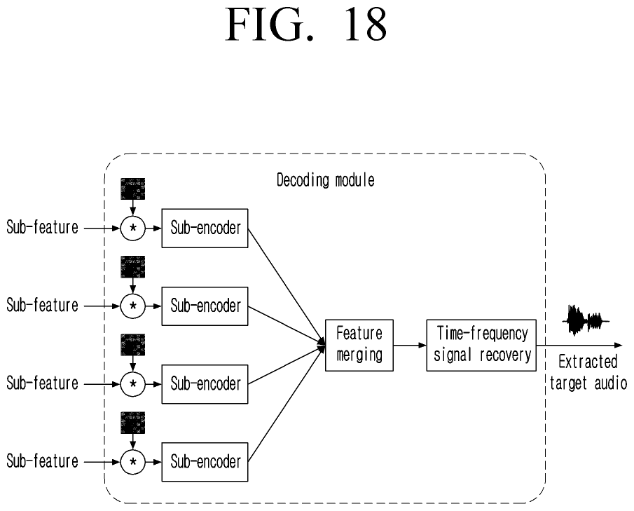

FIG. 18 is a schematic structure diagram of a decoding module according to an embodiment of the disclosure.

Referring to FIG. 18, by taking the network structure of the decoding module shown in FIG. 18 as an example, as shown in FIG. 18, if the second audio feature of the second audio signal is divided into second audio features of a plurality of sub-bands, the feature of each sub-band may be decoded by using a plurality of sub-encoders, and the predicted feature of each preset frequency band is merged, so that the time-domain signal is recovered based on the merged feature and the target audio signal of the registration sound source is extracted.

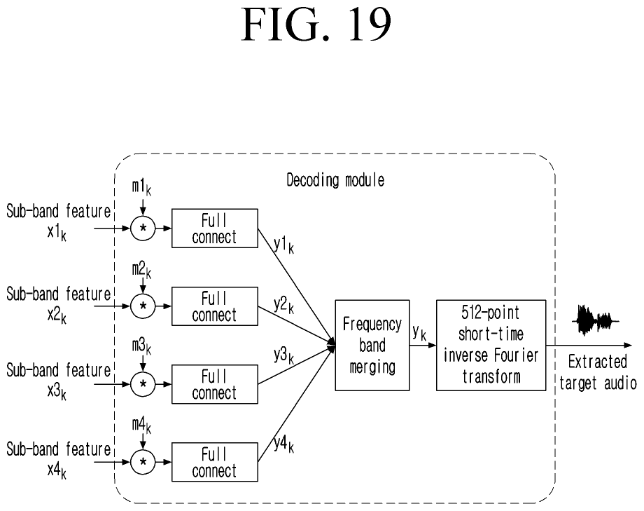

FIG. 19 is a schematic diagram of a network structure of a decoding module according to an embodiment of the disclosure.

Referring to FIG. 19, the predicted features corresponding to each preset frequency band can be obtained by using the sub-decoder corresponding to each preset frequency band. For example, by using the decoding module, a point multiplication operation is performed on corresponding elements of the sub-band mask miₖ predicted by the voice extraction module and the sub-band feature xiₖ in the second audio signal output by the second encoding module; and, the result of the point multiplication operation is input into a linear full connected layer or other networks capable of realizing feature transformation (e.g., CNN) to calculate the predicted feature yiₖ of the target speaker, where i represents the i^{th} sub-band and k represents the k^{th} frame. Then, the predicted feature yiₖ of each sub-band is merged to obtain yₖ, to facilitate the subsequent feature transformation process. Finally, the time-domain signal is recovered. The specific technology of the decoding module may be implemented by short-time inverse Fourier transform or other feature transformation methods. For example, the audio signal is recovered by a CNN network. In the embodiments of the application, since the first encoding module and the second encoding module perform feature extraction by short-time Fourier transform, the decoding module performs inverse Fourier transform on the feature to obtain the time-domain signal of the target speaker to be extracted.

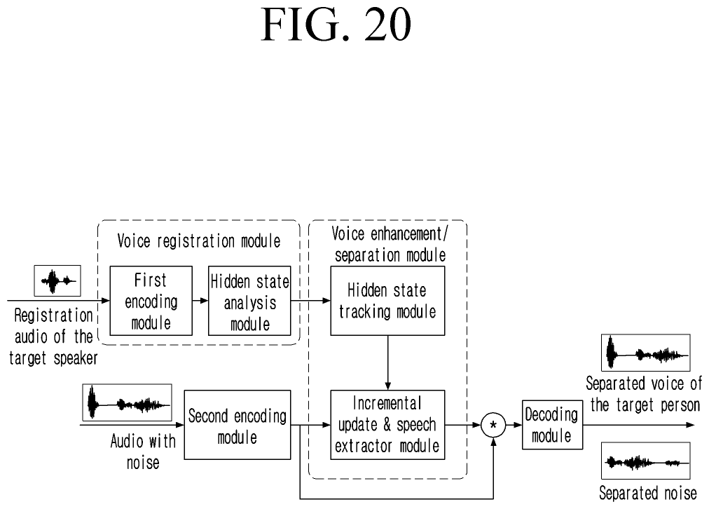

FIG. 20 is a schematic diagram of a network structured applied to other tasks based on a voice extraction network according to an embodiment of the disclosure.

Referring to FIG. 20, the audio processing method of the application can be applied to voice extraction tasks, but can also be used in voice enhancement, voice separation and other tasks, without changing the network structure of the audio processing model. Referring to FIG. 20, the audio processing model may include four parts, i.e., a second encoding module, a voice registration module, a voice extraction module and a decoding module. Each module is the same as the module shown in FIG. 5. In the audio processing model, the input of the voice registration module includes the registration audio of the target speaker. The input of the second encoding module may include audio with noise. Through the above modules and by the audio signal processing method of the application, the voice of the target speaker separated from the audio with noise can be obtained, and the noise separated from the audio with noise can also be obtained. That is, without modifying the model, various tasks such as voice extraction, voice enhancement and voice separation can be realized by the audio processing method of the application by changing only the input training data and the training object.

The execution steps in an interaction scenario between a computer device and a user will be provided below. The audio signal processing method of the application may further include the following operations C1 to C3.

At operation C1, the computer device outputs an audio signal to be processed to the user.

The audio signal to be processed may be a piece of audio, or audio in a piece of audio/video. For example, in a voice call scenario, a device (e.g., a smart headphone, a smart phone, a wired phone, etc.) may automatically play, to the user, the voice from the other party of the call. For another example, in an audio/video playback scenario, a multimedia playback device (e.g., a smart television (TV) set, a smart phone, a tablet computer, a sound recorder, etc.) may play a piece of audio or a piece of video with sound, etc.

At operation C2, the computer device receives processing instructions from the user.

The user may trigger an audio extraction service of the computer device as required. The processing instructions is used to instruct to extract the target audio signal from the second audio signal based on the first audio signal.

At operation C3, the computer device determines the first audio signal and the second audio signal based on the processing instructions and the audio signal to be processed.

The computer device may determine the first audio signal from the audio signal to be processed based on the processing instructions. In addition, the computer device may use the audio to be processed as the second audio signal. Exemplarily, one executable mode of the operation C3 includes the following: the computer device determines, as the first audio signal, a first audio segment whose starting frame is a frame corresponding to the processing instructions and whose duration is a preset duration in the audio signal to be processed; and, the computer device determines a second audio segment subsequent to the first audio segment in the audio signal to be processed as the second audio signal. The frame corresponding to the processing instructions may be a frame output at the current moment when the computer device receives the processing instructions, or a frame with an audio index satisfying the preset condition in a piece of audio within a specified time starting from the current moment. For example, within 2 s starting from the current moment, if the definition of the audio from is to 1.5 s is not less than the preconfigured threshold, the frame at 1 s is used as a starting frame, and the audio from is to 1.5 s is used as the first audio signal. For example, the preset duration may be a preconfigured ultra-short duration, e.g., 0.5 s, 0.6 s, 0.53 s, etc.

In one possible scenario, the user may trigger the audio extraction service of the device in real time according to the currently heard audio. For example, in a voice call scenario, when a user A has a voice call with a user B, the user A hears the voice of the user B through a smart headphone. In the process of playing the voice of the user B through the smart headphone, the user A can trigger the processing instructions at any time. The computer device may quickly acquire the first audio signal based on the trigger operation of the user A, so as to obtain the registration feature of the user B. Then, the target audio signal of the user B is extracted from the subsequently received voice, thereby effectively filtering out the environmental noise.

In the audio signal processing method provided by the disclosure, a first hidden state corresponding to a voice registration module is acquired by using the voice registration module based on a first audio signal, so that implicit features of the concerned sound source are obtained quickly, and a target audio signal is extracted from a second audio signal based on the first hidden state, so that the target audio signal can be extracted without extracting explicit features based on long-time audio of a registration sound source. Accordingly, the registration time is saved, the efficiency of audio signal processing is improved, and the practicability of the audio signal processing method is improved.

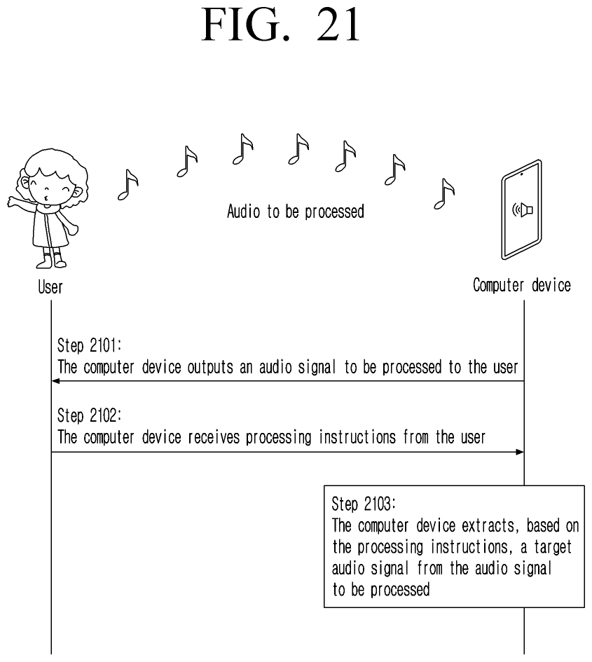

FIG. 21 is a schematic diagram of an interaction scenario of an audio signal processing method according to an embodiment of the disclosure.

Referring to FIG. 21, the execution subject of the audio signal processing method is a computer device, and the computer device may be a terminal, a server, a smart headphone, a smart phone, a vehicle-mounted terminal, etc. The computer device executes the audio signal processing method based on the interaction with the user. This method may include the following steps.

At operation 2101, the computer device outputs an audio signal to be processed to a user.

In an example of the scenario, the audio signal to be processed may be an already-output signal with a limited duration, for example, a piece of audio that exists locally and is already output. In the application, a target audio signal can be extracted from the piece of already-output audio. For example, after listening to a piece of audio, the user filters out the noise in this piece of audio or the voice of a person concerned in this piece of audio.

In another example of the scenario, the audio signal to be processed may also be an audio signal that is output in real time and has an unknown duration. For example, when two users are being in a voice call, a user will receive and input the voice towards the opposite party in real time. For another example, the terminal is playing a live online concert.

At operation 2102, the computer device receives processing instructions from the user.

The user may trigger an audio extraction service of the computer device as required. The processing instructions is used to instruct to extract a target audio signal from a second audio signal based on a first audio signal.

For example, the user may trigger the processing instructions when hearing the audio of the concerned sound source, so that the computer device can determine a first audio signal based on the instruction trigger occasion, so as to obtain the audio signal of which sound source needs to be extracted.

At operation 2103, the computer device extracts a target audio signal from the audio signal to be processed based on the processing instructions.

In one possible implementation, the operation 2103 includes the following operations:

The computer device determines a first audio signal and a second audio signal based on the processing instructions and the audio signal to be processed.

Exemplarily, the computer device determines, as the first audio signal, a first audio segment whose starting frame is a frame corresponding to the processing instructions and whose duration is a preset duration in the audio signal to be processed. Also, a second audio segment subsequent to the first audio segment in the audio signal to be processed is determined as the second audio signal.

For example, the second audio signal may include an audio signal that is already output currently, or the second audio signal may also include an audio signal to be processed that is to be output subsequently. The implementation of the operation 21031 may the same process as the step C3, and will not be repeated here.

The computer device then acquires, by using a voice registration module based on the first audio signal, a first hidden state corresponding to the voice registration module.

Finally, the computer device extracts a target audio signal from the second audio signal based on the first hidden state.

It is to be noted that, the implementation of the above operations is the same process as the operations 201 to 202, and will not be repeated here.

In the audio signal processing method provided by the application, an audio signal to be processed is output to a user; and when processing instructions from the user is received, a target audio signal is extracted from the audio signal to be processed based on the processing instructions. Thus, the extraction of the target audio signal from the audio signal to be processed can be realized by the audio signal processing method of the application, and the target audio signal can be extracted without extracting explicit features based on long-time audio of a registration sound source. Accordingly, the registration time is saved, the efficiency of audio signal processing is improved, and the practicability of the audio signal processing method is improved.

The application scenarios involved in the application will be illustrated below.

Scenario 1: Audio Focusing, which Focuses on the Sound the User is Concerned about.

The audio focusing means the extraction of the sound of the concerned person (target speaker), and can also realize quick switching between different target speakers. The voice extraction technology provided by the disclosure may be used in an audio focusing scenario. By using the ultra-short voice registration function of the disclosure, the user can select target voice for registration at any time, and extract the target voice.

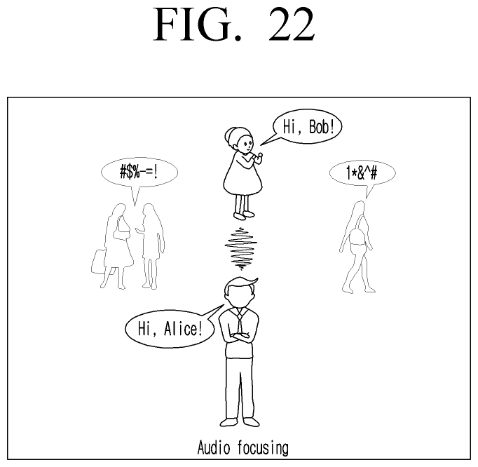

FIG. 22 is a schematic diagram of the audio focusing scenario according to an embodiment of the disclosure.

Referring to FIG. 22, for a scenario requiring audio focusing, the operations of voice registration and extraction in this scenario are described below.

At operation a, a user A (Bob shown in FIG. 22) wears the TWS headphone in a noisy environment (e.g., subway, shopping center), and the headphone activates active noise cancellation (ANC) to keep the environment quiet. At this time, he cannot hear the voice of a target user B (Alice shown in FIG. 22).

At operation b, to have a smooth chat with the user B in the current environment, at a certain moment, when the user B is talking and the surrounding noise is very small, the user A clicks the TWS device to start the audio signal processing method of the application, so as to provide a voice extractor (VE) function and register the user B as a speaker.

At operation c, in the subsequent conversation, the voice of the user B is extracted from the noisy signal acquired by the headphone by using the voice extraction solution of the disclosure. In this way, the user A only needs to pay attention to the chat with the user B, and will not be affected by the surrounding noise.

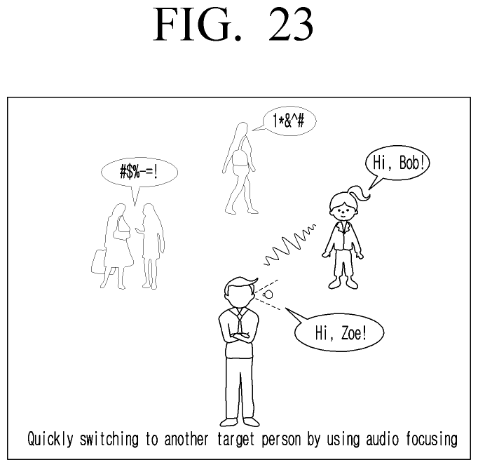

FIG. 23 is a schematic diagram of a scenario of quick switching during audio focusing according to an embodiment of the disclosure.

Referring to FIG. 23, for a scenario where the speaker needs to be switched quickly, as shown in FIG. 23, a quick switching can be realized between different speakers for audio focusing. It is assumed that the user A meets a user C (Zoe shown in FIG. 23) and wants to chat with the user C after chatting with the user B. The steps of voice registration and extraction in this scenario are described below.

At operation a, first, when the user C talks, the user A clicks the TWS device again to activate the VE function of the disclosure. Since the disclosure supports ultra-short-time registration, voice registration can be completed by using only 0.5 audio of the user C, so that an effect of instant registration is achieved.

At operation b, in the subsequent chat, the TWS device only extracts the sound of the user C, thereby realizing the user A's focus on the sound of the user C and realizing the quick switching of the target speaker from the user B to the user C.

Scenario 2: Extraction of the Target Sound During Video Playback

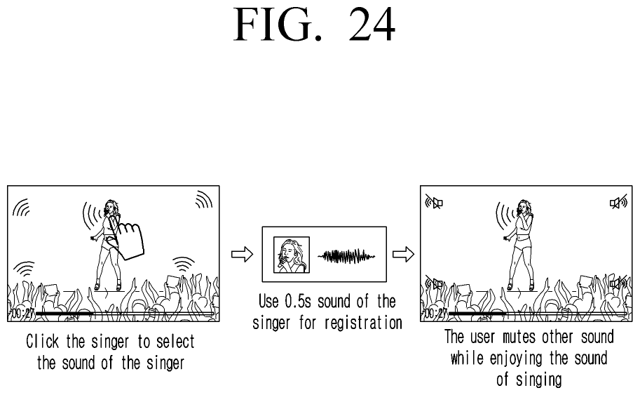

FIG. 24 is a schematic diagram of a scenario in which target sound is extracted from the video according to an embodiment of the disclosure.

Referring to FIG. 24, the audio signal processing method provided by the application can be used in an audio/video playback scenario. Referring to FIG. 24, when a user watches a video such as a concert, wants to pay attention to the singer and mutes other environment noise such the audience's sound, the user can execute the following operations.

At operation a, when a user watches a concert video and when the singer interested by the user is singing, the user clicks the singer on the screen (or clicks the screen) to activate the VE function.

At operation b, the voice of the singer in 0.5 s after the current moment is selected for instant registration by the VE solution provided by the disclosure.

At operation c, after the completion of instant registration, the singer's voice is extracted from the subsequent video playback by the solution provided by the disclosure.

At operation d, by the VE solution provided by the application, the user mutes the environment noise while enjoying the sound of singing of the singer.

Scenario 3: Removal of the Target Sound During Video Recording

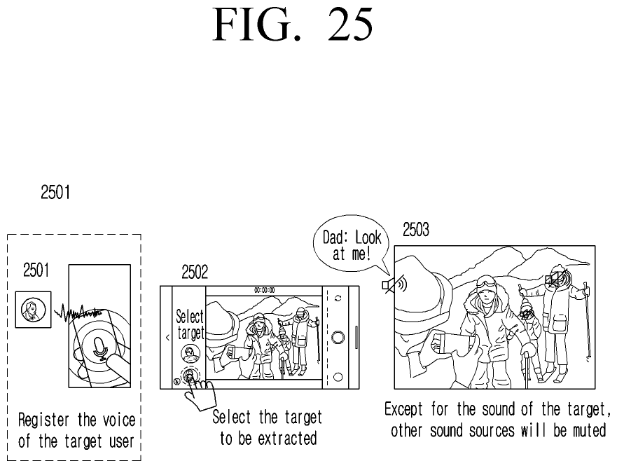

FIG. 25 is a schematic diagram of a scenario in which non-target sound is removed during video recording according to an embodiment of the disclosure.

Referring to FIG. 25, the application may be applied in a video recording scenario. Referring to FIG. 25, a user records the concerned sound in the video recording process, and shields the sound that is not concerned. Usually, in this scenario, the sound of the target user may be registered in advance, or may be registered during recording. The steps in this application scenario may be described below.

At 2501, the user registers the sound of family members in advance, and saves the registration information in a device (e.g., a mobile phone.

At operation 2502, at the beginning recording, a target character to be concerned is selected.

At operation 2503, by the VE solution provided by the disclosure, the sound of the concerned target person is extracted from the source audio, and other sound such as environmental noise and other persons' sound are shielded. Thus, only the sound of the target person is reserved in the recorded video.

In addition to registering the target person in advance, the sound of the non-target person can also be instantly registered and removed during recording in this scenario. At the moment when only the target user B speaks, clicking is conducted to start recording, and the recording software selects the sound in 0.5 s from the current moment as the sound of the target person to be extracted (i.e., the sound of the target user B). Thus, in the subsequent recording process, only the sound of the target person is recorded, and other sound is shielded.

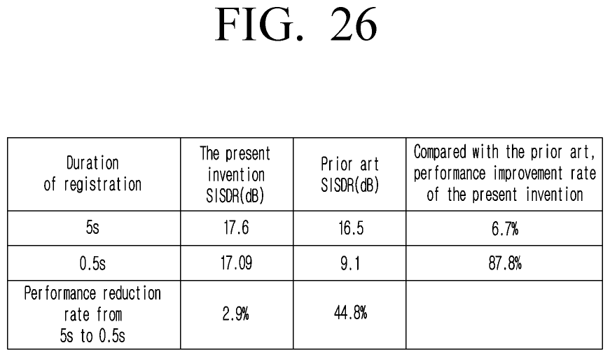

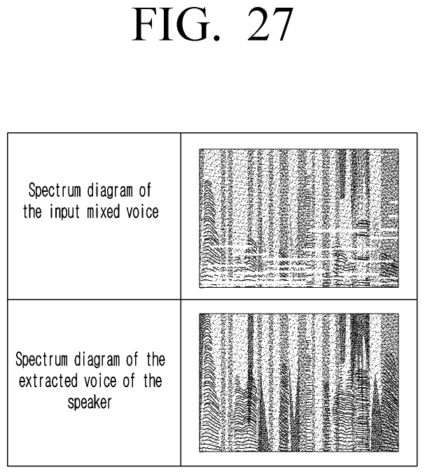

In addition, as shown in FIGS. 26 and 27, the actual measurement results of extraction of the target person in the application are shown in FIGS. 26 and 27.

FIG. 26 is a comparison diagram of the actual measurement results of extracting the voice of a target speaker according to an embodiment of the disclosure.

FIG. 27 is an effect diagram of processing an audio signal by using the method of the application according to an embodiment of the disclosure.

Referring to FIGS. 26 and 27, the standard test set SparseLibriMix is tested by the method of the disclosure and the method in the prior art, respectively. When 5 s registration voice is used, the SISDR of the disclosure reaches 17.6 dB, while the SISDR of the prior art is 16.5 dB. Compared with the related art, the performance of disclosure is improved by 6.7%. When 0.5 registration voice is used, the SISDR of the disclosure reaches 17.09 dB, and the SISDR of the prior art is decreased to 9.1 dB. It is obvious that, compared with the performance when the 5 s registration voice is used, when using 0.5 s registration voice, the performance of the disclosure is only decreased by 2.9%, while the performance of the prior art is decreased by 44.8%. That is, as compared with the performance of the prior art, the performance of the disclosure is improved by 87.8%. FIG. 27 is an effect diagram of the disclosure. As shown in the spectrum diagram of the speaker's voice extracted by the method of the disclosure in FIG. 27, the disclosure can well extract clear voice of the speaker from the mixed voice.

The related technologies involved in the application will be described below.

The application relates to the technical field of artificial intelligence. Artificial intelligence is a theory, method, technology and application system that uses a digital computer or a machine controlled by the digital computer to simulate, extend and expand human intelligence, perceive the environment, acquire knowledge and achieve the best results using the knowledge. Artificial intelligent is a comprehensive technology of the computer science, which attempts to understand the essence of intelligence and produce a new intelligence machine that can respond in a similar way to human intelligence.

Specifically, the application may relate to machine learning. Machine learning specifically studies how computers simulate or realize human learning behaviors to acquire new knowledge or skills, and reorganizes the existing knowledge structure to continuously improve its performance. Machine learning and deep learning usually include artificial neural networks, confidence networks, reinforcement learning, transfer learning, inductive learning, teaching-based learning and other technologies. In the application, by using the neural network model obtained by artificial intelligence, machine learning or other technologies, the audio signal processing method of the application can be implemented to extract the target audio signal in the second audio signal.

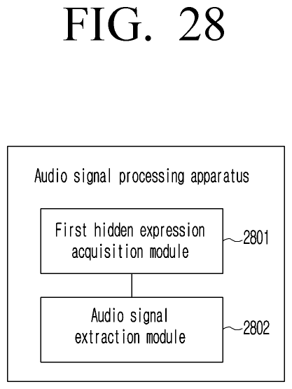

FIG. 28 is a schematic structure diagram of an audio signal processing apparatus according to an embodiment of the disclosure.

Referring to FIG. 28, the apparatus includes: a first hidden state acquisition module 2801 configured to acquire, by using a voice registration module based on a first audio signal, a first hidden state corresponding to the voice registration module, and an audio signal extraction module 2802 configured to extract, based on the first hidden state, a target audio signal from a second audio signal.

In one possible implementation, the voice registration module includes a first encoding module and a hidden state analysis module.

The first hidden state acquisition module 2801 includes: a first audio feature extraction unit configured to extract, by using the first encoding module, a first audio feature of the first audio signal; and a first hidden state acquisition unit configured to perform, by using the hidden state analysis module based on the first audio feature, feature extraction to acquire a first hidden state of the hidden state analysis module during feature extraction.

In one possible implementation, the first hidden state acquisition unit is configured to: for each frame in the first audio signal, successively perform the following: performing, by using the hidden state analysis module based on the first audio feature of the current frame, feature extraction to acquire a first hidden state of the hidden state analysis module during feature extraction; and updating the first hidden state of the hidden state analysis module based on the acquired first hidden state.

In one possible implementation, the first audio feature extraction unit is configured to: perform time-frequency transform process on the first audio signal to obtain sub-band features corresponding to at least two preset frequency bands; and extract, by using a first encoding module respectively corresponding to each preset frequency band based on the sub-band features of the preset frequency band, the first audio feature corresponding to the preset frequency band.

In one possible implementation, the hidden state analysis module includes at least one of the following: a recurrent neural network, an attention network, a transformer network and a convolutional network.

In one possible implementation, the audio signal extraction module 2802 includes: a second audio feature extraction unit configured to extract, by using a second encoding module, a second audio feature of the second audio signal; a mask information extraction unit configured to extract, by using a voice extraction module based on the first hidden state and the second audio feature, mask information corresponding to the target audio signal from the second audio signal; and a target audio signal determination unit configured to determine, by using a decoding module based on the second audio feature of the second audio signal and the mask information, the target audio signal.

In one possible implementation, the apparatus further includes: a hidden state updating module configured to update a second hidden state of the voice extraction module.

In one possible implementation, the second audio signal includes at least one block, and each block includes at least one frame; and the hidden state updating module is configured to: predict, based on the first hidden state corresponding to the voice registration module and a historical second hidden state of the voice extraction module, the second hidden state of the voice extraction module when processing the current block; and update the second hidden state of the voice extraction module based on the predicted second hidden state.

In one possible implementation, the hidden state updating module is configured to: predicting, by using a window attention module based on the first hidden state corresponding to the voice registration module and the historical second hidden state of the voice extraction module, the second hidden state of the voice extraction module when processing the current block.

In one possible implementation, the historical second hidden state of the voice extraction module includes: the second hidden state of the voice extraction module when the voice extraction module processes a preset frame of a preset block preceding the current block.

In one possible implementation, the mask information extraction unit is configured to: for each frame in each block in the second audio signal, successively perform the following: extracting, by using the voice extraction module based on the second hidden state of the voice extraction module and the second audio feature of the current frame, mask information corresponding to the current frame from the second audio signal; acquiring the second hidden state of the voice extraction module when extracting the mask information corresponding to the current frame; and updating, based on the acquired second hidden state, the second hidden state of the voice extraction module.

In one possible implementation, the second audio feature includes sub-band features of at least two preset frequency bands of the second audio signal, and the mask information includes mask information of each preset frequency band; and the target audio signal determination unit is configured to: determine, by using a decoding module respectively corresponding to each preset frequency band based on the sub-band features of each preset frequency band and the mask information, predicted features of each preset frequency band; and determine the target audio signal based on the predicted features of each preset frequency band.

In one possible implementation, the voice extraction module includes at least one of the following: a recurrent neural network, an attention network, a transformer network and a convolutional network.

In one possible implementation, the apparatus further includes: an output module configured to output an audio signal to be processed to a user; a receiving module configured to receive processing instructions from the user; and a determination module configured to determine the first audio signal and the second audio signal based on the processing instructions and the audio signal to be processed.

In one possible implementation, the determination module is configured to: determine, as the first audio signal, a first audio segment whose starting frame is a frame corresponding to the processing instructions and whose duration is a preset duration in the audio signal to be processed; and determine a second audio segment subsequent to the first audio segment in the audio signal to be processed as the second audio signal.

In the audio signal processing apparatus provided by the disclosure, a first hidden state corresponding to a voice registration module is acquired by using the voice registration module based on a first audio signal, so that implicit features of the concerned sound source are obtained quickly; and, a target audio signal is extracted from a second audio signal based on the first hidden state, so that the target audio signal can be extracted without extracting explicit features based on long-time audio of a registration sound source. Accordingly, the registration time is saved, the efficiency of audio signal processing is improved, and the practicability of the audio signal processing method is improved.

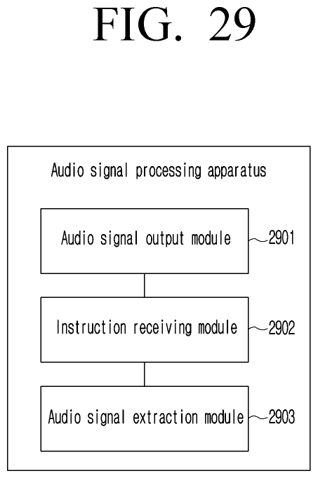

FIG. 29 is a schematic structure diagram of an audio signal processing apparatus according to an embodiment of the disclosure.

Referring to FIG. 29, the apparatus includes: an audio signal output module 2901 configured to output an audio signal to be processed to a user; an instruction receiving module 2902 configured to receive processing instructions from the user; and an audio signal extraction module 2903 configured to extract, based on the processing instructions, a target audio signal from the audio signal to be processed.

In one possible implementation, the audio signal extraction module 2903 is configured to: determine a first audio signal and a second audio signal based on the processing instructions and the audio signal to be processed; acquire, by using a voice registration module based on the first audio signal, a first hidden state corresponding to the voice registration module; and extract, based on the first hidden state, a target audio signal from the second audio signal.

In one possible implementation, the audio signal extraction module 2903 is configured to: determine, as the first audio signal, a first audio segment whose starting frame is a frame corresponding to the processing instructions and whose duration is a preset duration in the audio signal to be processed; and determine a second audio segment subsequent to the first audio segment in the audio signal to be processed as the second audio signal.

In the audio signal processing apparatus provided by the application, an audio signal to be processed is output to a user, and when processing instructions from the user are received, a target audio signal is extracted from the audio signal to be processed based on the processing instructions. Thus, the extraction of the target audio signal from the audio signal to be processed can be realized by the audio signal processing method of the application, and the target audio signal can be extracted without extracting explicit features based on long-time audio of a registration sound source. Accordingly, the registration time is saved, the efficiency of audio signal processing is improved, and the practicability of the audio signal processing method is improved.

In the audio processing apparatus provided by the application, by acquiring a first hidden state of a first audio signal of a registration sound source, a hidden layer state representing the registration sound source is obtained, and the target audio signal is extracted from the second audio signal by using the first hidden state, so that the voice of the registration sound source can be extracted without extracting explicit features based on long-time audio of the registration sound source, and the efficiency of audio signal processing is improved.

The apparatus in the embodiment of the application can execute the methods provided in the embodiments of the application, and the implementation principles thereof are similar. The actions performed by the modules in the apparatus in the embodiment of the application correspond to the steps in the methods in the embodiments of the application. For the detailed functional description of the modules in the apparatus, reference may be made to the description of the corresponding methods shown above, and details will not be repeated here.

In accordance with the disclosure, in the method executed by the computer device, an audio signal processing method for recognizing a user's voice and interpreting the user's intention can receive a voice signal which is an analog signal via voice acquisition device (e.g., a microphone) and uses an automatic voice recognition (ASR) model to convert the voice part into computer-readable text. The user's utterance intention can be obtained by interpreting the converted text using the natural language understanding (NLU) model. The ASR model or the NLU model may be an AI model. The AI model may be processed by an AI-specific processor designed in the hardware structure specified for processing the AI model. The AI model may be obtained by training. Here, “obtaining by training” means that predefined operating rules or artificial intelligence models configured to perform desired features (or purposes) are obtained by training a basic artificial intelligence model with multiple pieces of training data by training algorithms. The AI model may include a plurality of neural network layers. Each of the plurality of neural network layers includes a plurality of weight values, and neural network calculation is performed by calculation between the calculation result of the previous layer and a plurality of weight values.

Language understanding is a technology used to recognize and apply/process human language/text, for example, including natural language processing, machine translation, dialogue system, question and answer, or voice recognition/synthesis.

The apparatus provided in the embodiments of the application may implement at least one module among multiple modules through an AI model. AI-related functions may be performed by non-volatile memories, volatile memories and processors.

The processor may include one or more processors. In this case, the one or more processors may be general-purpose processors such as central processing units (CPUs), application processors (APs), etc., or pure graphics processing units such as graphics processing units (GPUs), visual processing Units (VPUs), and/or AI-specific processors such as neural processing units (NPUs).

The one or more processors control the processing of input data according to the predefined operating rules or AI models stored in non-volatile memories and volatile memories. The predefined operating rules or AI models are provided by training or learning.

Here, providing by learning refers to obtaining predefined operating rules or AI models having desired characteristics by applying learning algorithms to multiple pieces of learning data. This learning may be performed in the apparatus itself in which the AI according to an embodiment is performed, and/or may be implemented by a separate server/system.

The AI model may contain a plurality of neural network layers. Each layer has a plurality of weight values. The calculation of a layer is performed by the calculation result of the previous layer and a plurality of weights of the current layer. Examples of neural networks include, but not limited to, convolutional neural networks (CNN), deep neural networks (DNN), recurrent neural networks (RNN), restricted Boltzmann machines (RBM), deep belief networks (DBN), bidirectional recurrent deep neural networks (BRDNN), generative adversarial networks (GAN), and deep Q-networks.

A learning algorithm is a method of training a predetermined target apparatus (e.g., a robot) using multiple pieces of learning data to cause, allow or control the target apparatus to make determinations or predictions. Examples of such learning algorithms include, but not limited to, supervised learning, unsupervised learning, semi-supervised learning or reinforcement learning.

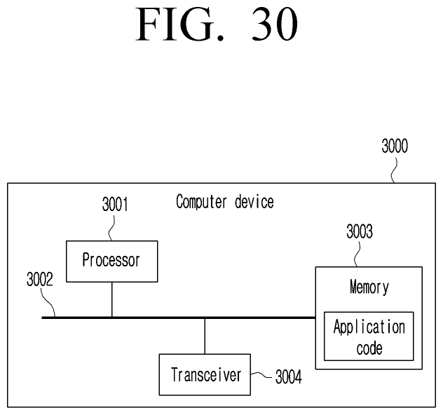

FIG. 30 is a schematic structure diagram of a computer device according to an embodiment of the disclosure.

Referring to FIG. 30, the computer device 3000 includes: a memory 3003, a processor 3001, a bus 3002, a transceiver 3004, and computer programs stored in the memory. The processor executes the above computer programs to implement the steps of the audio signal processing method. Compared with the related technologies, the following effects can be achieved.

In the audio signal processing method provided by the disclosure, a first hidden state corresponding to a voice registration module is acquired by using the voice registration module based on a first audio signal, so that implicit features of the concerned sound source are obtained quickly; and, a target audio signal is extracted from a second audio signal based on the first hidden state, so that the target audio signal can be extracted without extracting explicit features based on long-time audio of a registration sound source. Accordingly, the registration time is saved, the efficiency of audio signal processing is improved, and the practicability of the audio signal processing method is improved.

In the audio signal processing method provided by the application, an audio signal to be processed is output to a user, and when processing instructions from the user are received, a target audio signal is extracted from the audio signal to be processed based on the processing instructions. Thus, the extraction of the target audio signal from the audio signal to be processed can be realized by the audio signal processing method of the application, and the target audio signal can be extracted without extracting explicit features based on long-time audio of a registration sound source. Accordingly, the registration time is saved, the efficiency of audio signal processing is improved, and the practicability of the audio signal processing method is improved.

In an optimal embodiment, a computer device is provided, as shown in FIG. 30. The computer device 3000 shown in FIG. 30 includes a processor 3001 and a memory 3003. The processor 3001 is connected to the memory 3003, for example, via a bus 3002. Optionally, the computer device 3000 may further include a transceiver 3004. The transceiver 3004 may be configured for data interaction between the computer device and other computer devices, for example, data transmission and/or data reception, etc. It is to be noted that, in practical applications, the number of the transceiver 3004 is not limited to one, and the structure of the computer device 3000 does not constitute any limitation to the embodiments of the application.

The processor 3001 may be a central processing unit (CPU), a general-purpose processor, a digital signal processor (DSP), an application specific integrated circuit (ASIC), a field programmable gate array (FPGA) or other programmable logic devices, transistor logic devices, hardware components or any combination thereof. The processor can implement or execute various logic blocks, modules and circuits described in the disclosure of the application. The processor 3001 may also be a combination of functions for implementing computing, for example, a combination of one or more microprocessors, a combination of DSPs and microprocessors, etc.

The bus 3002 may include a passageway for transferring information between the above components. The bus 3002 may be a peripheral component interconnect (PCI) bus, an extended industry standard architecture (EISA) bus, etc. The bus 3002 may be classified into address bus, data bus, control bus, etc. For ease of representation, the bus is represented by only one bold line in FIG. 30, but it does not mean that there is only one bus or one type of buses.

The memory 3003 may be, but not limited to, read only memories (ROMs) or other types of static storage devices capable of storing static information and instructions, random access memories (RAMs) or other types of dynamic storage devices capable of storing information and instructions, or electrically erasable programmable read only memories (EEPROMs), compact disc read only memories (CD-ROMs) or other optical disc storages, optical disc storages (including compact discs, laser discs, optical discs, digital versatile optical discs, Blue-ray discs, etc.), magnetic disc storage mediums or other magnetic storage devices, or any other media that can be used to carry or store computer programs and can be accessed by a computer.

The memory 3003 is configured to store computer programs for executing the embodiments of the application, and is controlled and executed by the processor 3001. The processor 3001 is configured to execute the computer programs stored in the memory 3003 to implement the steps in the above method embodiments.

The electronic device includes, but not limited to, a server, a terminal, a cloud computing center device, etc.

An embodiment of the application provides a computer-readable storage medium having computer programs stored thereon that, when executed by a processor, can implement the steps and corresponding contents in the above method embodiments.

An embodiment of the application further provides a computer program product, including computer programs that, when executed by a processor, can implement the steps and corresponding contents in the above method embodiments.

The terms “first”, “second”, “third”, “fourth”, “1”, “2”, etc. (if any) in the specification and claims of the application and the accompanying drawings are used for distinguishing similar objects, rather than describing a particular order or precedence. It should be understood that the used data can be interchangeable if appropriate, so that the embodiments of the application described herein can be implemented in an order other than the orders illustrated or described with text.

It should be understood that, although the operation steps are indicated by arrows in the flowcharts of the embodiments of the application, the implementation order of these steps is not limited to the order indicated by the arrows. Unless otherwise explicitly stated herein, in some implementation scenarios of the embodiments of the application, the implementation steps in the flowcharts may be executed in other orders as required. In addition, depending on practical implementation scenarios, some or all of the steps in the flowcharts may include a plurality of sub-steps or a plurality of stages. Some or all of these sub-steps or stages may be executed at the same moment, and each of these sub-steps or stages may be separately executed at a different moment. When each of these sub-steps or stages is executed at a different moment, the execution order of these sub-steps or stages may be flexibly configured as required, and will not be limited in the embodiments of the application.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An audio signal processing method, the method comprising:
acquiring, by using a voice registration module based on a first audio signal, a first hidden state corresponding to the voice registration module; and
extracting, based on the first hidden state, a target audio signal from a second audio signal.

2. The method according to claim 1,
wherein the voice registration module comprises a first encoding module and a hidden state analysis module, and
wherein the acquiring a first hidden state corresponding to the voice registration module comprises:
extracting, by using the first encoding module, a first audio feature of the first audio signal, and
performing, by using the hidden state analysis module based on the first audio feature, feature extraction to acquire the first hidden state of the hidden state analysis module during feature extraction.

3. The method according to claim 2, wherein the performing, by using the hidden state analysis module based on the first audio feature, feature extraction to acquire the first hidden state of the hidden state analysis module during feature extraction comprises:
for each frame in the first audio signal, successively performing the following based on an order of each frame:
performing, by using the hidden state analysis module based on a first hidden state corresponding to a frame preceding a current frame and the first audio feature of the current frame, feature extraction to acquire the first hidden state corresponding to the hidden state analysis module at the current frame at a time of feature extraction, and
updating the first hidden state of the hidden state analysis module based on the acquired first hidden state.

4. The method according to claim 2, wherein the performing, based on the first audio feature of a current frame, feature extraction to acquire the first hidden state of the hidden state analysis module, and updating the first hidden state of the hidden state analysis module based on the acquired first hidden state comprises:
for each frame in the first audio signal, successively performing the following based on an inverse order of each frame:
performing, by using the hidden state analysis module based on a first hidden state corresponding to a frame subsequent to the current frame and the first audio feature of the current frame, feature extraction to acquire the first hidden state corresponding to the hidden state analysis module at the current frame at a time of feature extraction, and
updating the first hidden state of the hidden state analysis module based on the acquired first hidden state.

5. The method according to claim 2, wherein the extracting, by using the first encoding module, a first audio feature of the first audio signal comprises:
performing a time-frequency transform process on the first audio signal to obtain sub-band features corresponding to at least two preset frequency bands; and
extracting, by using a first encoding module respectively corresponding to each preset frequency band based on the sub-band features of the preset frequency band, the first audio feature corresponding to the preset frequency band.

6. The method according to claim 2, wherein the hidden state analysis module comprises at least one of the following:
a recurrent neural network,
an attention network,
a transformer network, and
a convolutional network.

7. The method according to claim 1, wherein the extracting, based on the first hidden state, a target audio signal from a second audio signal comprises:
extracting, by using a second encoding module, a second audio feature of the second audio signal;
extracting, by using a voice extraction module based on the first hidden state and the second audio feature, mask information corresponding to the target audio signal from the second audio signal; and
determining, by using a decoding module based on the second audio feature of the second audio signal and the mask information, the target audio signal.

8. The method according to claim 7, further comprising:
updating a second hidden state of the voice extraction module.

9. The method according to claim 8,
wherein the second audio signal comprises at least one block, and each block comprises at least one frame; and
wherein the updating of the second hidden state of the voice extraction module comprises:
predicting, based on the first hidden state corresponding to the voice registration module and a historical second hidden state of the voice extraction module, the second hidden state of the voice extraction module when processing a current block, and
updating the second hidden state of the voice extraction module based on the predicted second hidden state.

10. The method according to claim 9, wherein the predicting, based on the first hidden state corresponding to the voice registration module and a historical second hidden state of the voice extraction module, the second hidden state of the voice extraction module when processing the current block comprises:
predicting, by using a window attention module based on the first hidden state corresponding to the voice registration module and the historical second hidden state of the voice extraction module, the second hidden state of the voice extraction module when processing the current block.

11. The method according to claim 9, wherein the historical second hidden state of the voice extraction module comprises:
the second hidden state of the voice extraction module when the voice extraction module processes a preset frame of a preset block preceding the current block.

12. The method according to claim 9, wherein the extracting, by using a voice extraction module based on the first hidden state and the second audio feature, mask information corresponding to the target audio signal from the second audio signal comprises:
for each frame included in each block in the second audio signal, successively performing the following:
extracting, by using the voice extraction module based on the second hidden state of the voice extraction module and the second audio feature of a current frame, mask information corresponding to the current frame from the second audio signal,
acquiring the second hidden state of the voice extraction module when extracting the mask information corresponding to the current frame, and
updating, based on the acquired second hidden state, the second hidden state of the voice extraction module.

13. The method according to claim 7,
wherein the second audio feature comprises sub-band features of at least two preset frequency bands of the second audio signal,
wherein the mask information comprises mask information of each preset frequency band, and
wherein the determining, by using a decoding module based on the second audio feature of the second audio signal and the mask information, the target audio signal comprises:
determining, by using a decoding module respectively corresponding to each preset frequency band based on the sub-band features of each preset frequency band and the mask information, predicted features of each preset frequency band, and
determining the target audio signal based on the predicted features of each preset frequency band.

14. The method according to claim 7, wherein the voice extraction module comprises at least one of the following:
a recurrent neural network,
an attention network,
a transformer network, and
a convolutional network.

15. The method according to claim 1, further comprising:
outputting an audio signal to be processed to a user;
receiving processing instructions from the user; and
determining the first audio signal and the second audio signal based on the processing instructions and the audio signal to be processed.

16. The method according to claim 1, wherein the first audio signal includes an audio signal from a registration sound source.

17. The method according to claim 16, wherein the registration sound source is a target speaker.

18. An electronic device comprising:
a microphone configured to receive a first audio signal and a second audio signal; and
a processor configured to:
acquire, by using a voice registration module based on the first audio signal, a first hidden state corresponding to the voice registration module, and
extract, based on the first hidden state, a target audio signal from the second audio signal.
